(19) United States
(12) Patent Application Publication
(10) Pub. No.: US 2026/0288614 A1
(43) Pub. Date: Sep. 24, 2026

(54) SYSTEM

(71) Applicant: SoftBank Group Corp., Tokyo (JP)

(72) Inventor: Masafumi NAGANO, Tokyo (JP)

(73) Assignee: SoftBank Group Corp., Tokyo (JP)

(21) Appl. No.: 19/567,332

(22) Filed: Mar. 16, 2026

(30) Foreign Application Priority Data
Mar. 19, 2025 (JP) 2025-045280

(51) Int. Cl. G06F 11/34; G06N 3/0475; G10L 15/22; H04L 51/02

(52) U.S. Cl. CPC G06F 11/3438; G06N 3/0475; G10L 15/22; H04L 51/02; G10L 2015/225

(57) ABSTRACT

A system comprising a processor, wherein the processor is configured to: convert a voice input from a user into text data by using a speech recognition algorithm, analyze the text data by using a natural language processing technique to understand an intention of the user, and generate an operation procedure based on the intention and present the operation procedure by using a speech synthesis technique and a display.

### CROSS-REFERENCE TO RELATED APPLICATION

This application is based on and claims priority under 35 USC 119 from Japanese Patent Application No. 2025-045280 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional user support systems for electronic devices and online services suffer from several problems. First, many systems do not provide an integrated mechanism that converts a user's voice input into text, understands the user's intention by natural language processing, and then generates concrete operation procedures in a form that is easy for the user to follow. As a result, users often need to navigate complex interfaces or manuals without clear, step-by-step guidance tailored to their spoken requests.

Second, existing interfaces are generally not adequately adapted to elderly users. Elderly users often face difficulties due to small display elements, complex menu structures, and insufficiently intuitive interaction flows. Conventional systems rarely generate interfaces that are automatically customized to the user's age or specific needs, which leads to usability problems and reduces the adoption of digital services by elderly users.

Third, conventional systems that support financial or commercial transactions usually provide static recommendations or rule-based suggestions that do not fully leverage a user's detailed transaction history. These systems typically do not utilize generative AI models to automatically produce prompt texts or guidance that propose optimized transaction methods tailored to the individual user's past behavior, preferences, and risk profile. Consequently, users may miss opportunities to execute more advantageous or efficient transactions.

Therefore, there is a need for a system including a processor that can: (i) accurately convert voice input into text, understand the user's intention, and generate and present operation procedures; (ii) automatically generate a customized interface suitable for elderly users; and (iii) generate prompt texts that propose optimal transaction methods based on a user's transaction history by using a generative AI model.

### SUMMARY

In order to solve the above-described problems, an aspect of the present invention provides a system comprising a processor, wherein the processor is configured to convert a voice input from a user into text data by using a speech recognition algorithm, analyze the text data by using a natural language processing technique to understand an intention of the user, and generate an operation procedure based on the intention and present the operation procedure by using a speech synthesis technique and a display. By executing these functions in an integrated manner, the processor enables the user to receive step-by-step operational guidance in response to natural voice queries, thereby reducing the need for manual navigation and improving overall usability.

According to another aspect of the present invention, the processor is further configured to generate a customized interface according to an age of the user in order to provide usage support for an elderly user. The processor may adjust at least one of font size, icon size, layout complexity, color contrast, and interaction flow based on an age parameter or an elderly user flag, thereby improving visibility and operability for elderly users and reducing operation errors.

According to still another aspect of the present invention, the processor is further configured to generate a prompt text that proposes an optimal transaction method based on a transaction history of the user by using a generative AI model. The processor may analyze past transaction patterns, frequency, amounts, and contextual factors, and then cause the generative AI model to produce a prompt text that includes a proposal or recommendation for an optimized transaction method. The processor may then present the prompt text to the user via the display and/or speech synthesis. In this way, the system can support the user in selecting advantageous transaction options tailored to the user's individual history and preferences.

The term “processor” refers to one or more hardware circuits, such as a central processing unit (CPU), a graphics processing unit (GPU), a digital signal processor (DSP), an application-specific integrated circuit (ASIC), a field-programmable gate array (FPGA), or a combination thereof, that executes instructions to perform operations described in the present specification and claims.

The term “voice input” refers to audio data representing spoken utterances of a user, including words, phrases, and sentences, that are captured by a microphone or other audio acquisition device and supplied to the system for processing.

The term “speech recognition algorithm” refers to software or firmware logic that analyzes audio data corresponding to a voice input and converts the audio data into text data representing the linguistic content of the spoken utterances.

The term “text data” refers to a sequence of characters, symbols, or tokens that represent words, phrases, or sentences derived from a user's voice input or used internally by the system for natural language processing.

The term “natural language processing technique” refers to a computational method, model, or algorithm, including but not limited to parsing, semantic analysis, intent classification, entity extraction, or language modeling, for analyzing text data expressed in a human language.

The term “intention of the user” refers to a meaning, purpose, or goal inferred by the system from the user's input, such as a desired operation, request, command, question, or transaction that the user intends the system to perform or assist with.

The term “operation procedure” refers to information indicating one or more steps, actions, or sequences of operations to be performed by the system, by the user, or by another device or application, in order to achieve the intention of the user.

The term “speech synthesis technique” refers to a method or algorithm, including text-to-speech (TTS) technology, that converts text data, including an operation procedure or a prompt text, into audible speech output.

The term “display” refers to any visual output device or component, such as a liquid crystal display (LCD), an organic light emitting diode (OLED) display, a touch screen, or a head-mounted display, that presents text, images, or graphical user interfaces to the user.

The term “customized interface” refers to a user interface whose visual or interactive properties, such as font size, icon size, layout, color scheme, or interaction flow, are adjusted or generated based on one or more attributes of the user, including age.

The term “age of the user” refers to an actual chronological age, an age range, or an age-related category of the user, which may be obtained from user registration information, user input, or an inferred profile.

The term “usage support for an elderly user” refers to assistance provided by the system to a user classified as elderly, including improved visibility, simplified operation, guided procedures, and other features that facilitate the user's interaction with the system or with external applications.

The term “generative AI model” refers to a machine learning model, such as a neural network-based language model or another generative model, that is capable of generating new text, including prompt texts or recommendations, based on input data.

The term “transaction history of the user” refers to stored data indicating one or more past transactions conducted by or for the user, such as purchase records, financial trades, payments, or other interactions, including associated times, amounts, counterparties, and contexts.

The term “prompt text” refers to a text string generated by the system and intended to guide, propose, or recommend an action to the user, including a proposed transaction method or a sequence of operations to be executed.

The term “optimal transaction method” refers to a transaction strategy, option, or procedure that is determined to be advantageous for the user according to one or more criteria, such as cost, efficiency, risk, expected return, or convenience, in view of the user's transaction history and preferences.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

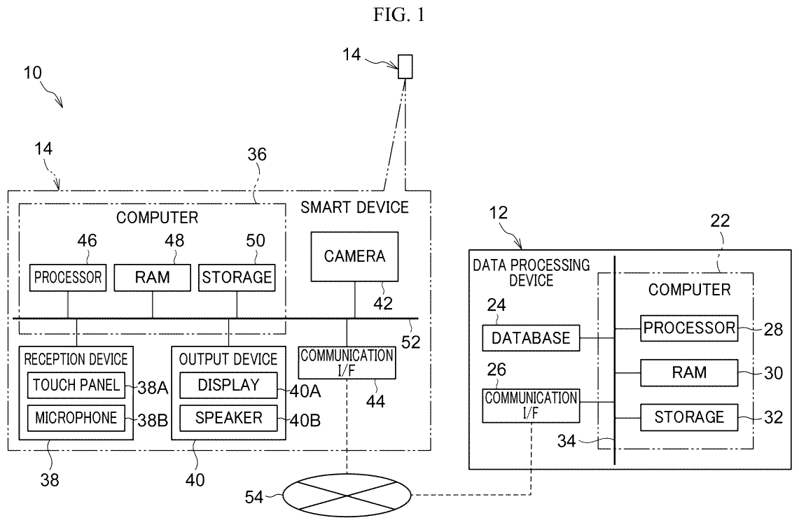

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

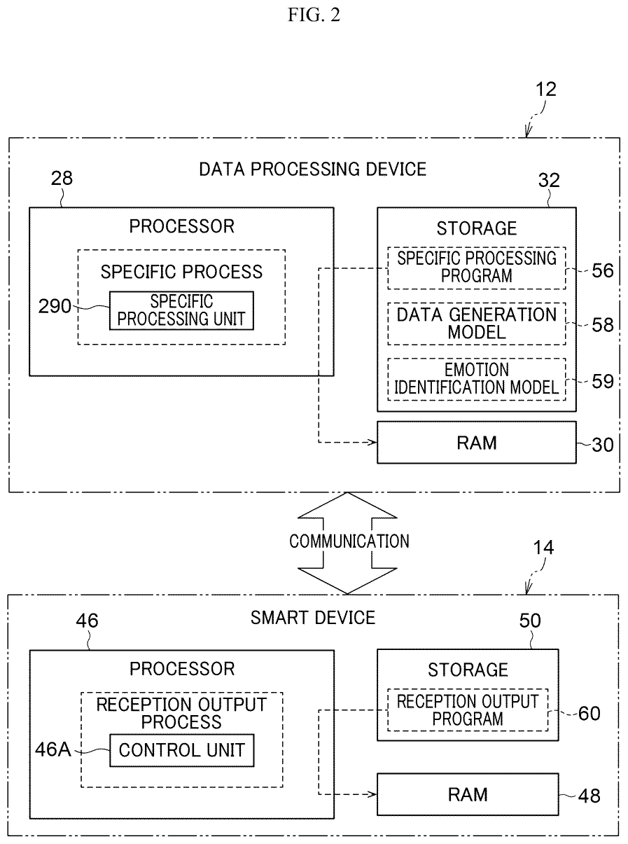

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented assistance systems that guide a user through device operations generally rely on static, manually designed scripts and generic user interfaces. Such systems treat natural language input, intent understanding, and user interface control as loosely connected components. As a result, these systems suffer from several technical limitations from a computer-technology perspective.

First, conventional systems typically convert speech to text and then execute fixed rule-based flows that are not aware of the current device configuration, such as model, screen layout, and installed applications. The processing pipeline does not exploit detailed device information when generating guidance. Consequently, the system must maintain many hard-coded variants of operation flows for different devices, which increases memory footprint, reduces maintainability, and often leads to incorrect or suboptimal guidance when the user interface changes due to software updates or customization.

Second, conventional systems do not leverage machine-learned generative models in a structured manner. Existing techniques may use language models to answer questions, but they do not systematically construct prompt sentences that incorporate device information, user attribute information, and usage history as machine-readable context. The absence of such structured prompt construction reduces the accuracy and robustness of intent inference and step-by-step instruction generation, causing higher error rates and requiring additional corrective interaction. This leads to inefficient utilization of computing resources in both the server and the terminal, as multiple iterations of interaction and processing are necessary.

Third, conventional guidance systems do not integrate intent understanding, UI element mapping, and multi-modal presentation into a unified, event-driven loop. Typically, a system may output text or audio descriptions, but it does not dynamically map each operation step to concrete UI elements on the current screen, nor does it continuously monitor user actions at the level of individual steps. This disjointed architecture causes redundant processing and delays, because the system must repeatedly re-scan the screen or re-interpret user progress, and cannot effectively synchronize visual highlights, speech output, and user operation events.

Fourth, prior systems generally do not treat usage history as a first-class computational resource for optimizing future processing. Operation histories may be logged for analytics, but are not tightly coupled with the generation of prompts and operation instructions in real time. Therefore, the system cannot predict likely next operations or adapt guidance complexity based on past behavior. This lack of adaptation leads to unnecessary computational workload (e.g., generating overly long explanations for experienced users, or repeatedly generating generic flows that do not match user preferences) and reduces the effectiveness of on-device and server-side computation.

Moreover, users with age-related or cognitive limitations are particularly impacted by these technical shortcomings. Because the system does not automatically adjust display parameters, audio parameters, and step granularity based on user attributes, the user interface may be visually or cognitively burdensome. From the perspective of computer technology, the system fails to exploit available user attribute information to dynamically configure rendering, speech synthesis, and interaction control. As a result, the device's processing resources are not used to generate interfaces and guidance that are actually usable and efficient for the target user population.

Accordingly, there is a need for an improved computer-implemented system and processing architecture that: (1) integrates speech recognition, structured prompt generation, generative AI inference, intent extraction, UI mapping, and multimodal step presentation into a cohesive processing pipeline; (2) uses device information, user attribute information, and operation history as structured inputs to the generative AI model; (3) dynamically associates generated steps with concrete UI elements and screen regions; (4) monitors operation events to advance steps automatically; and (5) personalizes both prompts and operation procedures based on historical usage. Such a system should improve the technical functioning of the device and the server by reducing misguidance, lowering processing redundancy, and enabling more efficient use of computational resources for real-time interactive assistance.

The specific processing by the specific processing unit 290 of the data processing device 12 in Example 1 is realized by the following means.

The present invention provides a server comprising a processor configured to receive, from a terminal, audio information representing a user utterance, convert the audio information into character information by performing speech recognition processing, and generate a prompt sentence for a generative AI model based on the character information and device information including at least model information of the terminal, screen information, and application information, and further configured to provide input information including the prompt sentence and the character information to the generative AI model, cause the generative AI model to generate response information including user intent and operation procedure information corresponding to the user intent, and transmit the response information to the terminal, the terminal comprising a processor configured to analyze the response information to extract intent information and the operation procedure information, convert the operation procedure information into a plurality of operation step information items that are associated with a screen configuration of the terminal and operation target elements, extract, for each of the plurality of operation step information items, an operation target region on a screen and superimpose visual guidance information including at least one of a highlight display, an arrow display, and a frame display on the operation target region, generate, for each of the plurality of operation step information items, an explanation sentence representing operation content, convert the explanation sentence into audio information by performing speech synthesis processing, and output the audio information via an output device, monitor operation events occurring in the terminal, determine whether an operation event corresponds to a current step among the plurality of operation step information items, and when the operation event corresponds to the current step, record the current step as completed and automatically transition to a next step, and store the operation events and the plurality of operation step information items as history information and, based on the history information, predict at least one of a future intent of the user and a next operation of the user and individualize at least one of the prompt sentence to the generative AI model and the operation procedure information based on a result of the prediction. This enables an integrated and adaptive computer-implemented guidance mechanism in which speech recognition, structured prompt construction, generative inference, UI element mapping, multimodal output generation, and event-driven step control cooperate to improve the accuracy, responsiveness, and resource efficiency of interactive assistance on computing devices, particularly for users requiring simplified and personalized operation support.

The term “audio information” refers to data representing sound captured from a user, including analog or digital signals obtained via an input device such as a microphone and suitable for processing by a speech recognition component.

The term “character information” refers to textual data obtained by converting audio information into a sequence of characters or symbols using speech recognition processing, and which can be further processed by natural language or related algorithms.

The term “speech recognition processing” refers to a computational procedure that analyzes audio information and outputs corresponding character information, using techniques such as acoustic modeling, language modeling, and decoding.

The term “device information” refers to information indicating at least one characteristic of a computing device, including but not limited to model information, screen information, and application information.

The term “model information” refers to data indicating a type, model name, model number, hardware configuration, or operating environment of a computing device.

The term “screen information” refers to data representing a display configuration of a device, including but not limited to screen size, resolution, orientation, layout parameters, and current screen state.

The term “application information” refers to data indicating installed software components on a device, including identifiers, names, versions, capabilities, and availability of applications.

The term “prompt sentence” refers to structured text provided as input to a generative AI model, the text including at least a representation of a user request and contextual information such as device information or history information.

The term “generative AI model” refers to a machine-learned computational model that generates output data, such as text or structured data, in response to input data, using techniques including neural networks, language models, or other probabilistic generation mechanisms.

The term “input information” refers to data provided to a generative AI model, including at least a prompt sentence and character information and optionally contextual information such as device information or history information.

The term “response information” refers to output data generated by a generative AI model in response to input information, the output data including at least user intent and operation procedure information.

The term “user intent” refers to a representation of a purpose, goal, or desired operation expressed by a user through input such as speech or text.

The term “operation procedure information” refers to data describing at least one sequence of actions or operations to be executed on a computing device in order to achieve a user intent.

The term “intent information” refers to structured data derived from response information that explicitly represents user intent in a machine-readable form.

The term “operation step information” refers to data representing a unitary step within operation procedure information, the data including at least a description of an action and an association with a screen configuration or operation target element.

The term “screen configuration” refers to information indicating a layout, composition, or arrangement of visual elements displayed on a screen of a device at a given time.

The term “operation target element” refers to a controllable user interface component on a screen, such as a button, icon, field, or control, that can be selected or manipulated to perform an operation.

The term “operation target region” refers to a portion of a display area associated with an operation target element, the portion being used to determine where visual guidance information is to be superimposed.

The term “visual guidance information” refers to graphical content that is displayed on a screen to direct user attention or indicate an operation target region, including at least one of a highlight display, an arrow display, and a frame display.

The term “highlight display” refers to a type of visual guidance information in which an operation target region is visually emphasized, for example, by changing color, brightness, transparency, or other visual property.

The term “arrow display” refers to a type of visual guidance information in which an arrow-shaped graphic is presented pointing toward or overlaying an operation target region.

The term “frame display” refers to a type of visual guidance information in which a border, outline, or box is drawn around an operation target region.

The term “explanation sentence” refers to textual data that describes an operation or a step of an operation procedure in natural language suitable for display or speech synthesis.

The term “speech synthesis processing” refers to a computational procedure that converts text, including an explanation sentence, into synthetic audio information that can be reproduced by an audio output device.

The term “output device” refers to a hardware component or combination of components capable of presenting information to a user, including at least a display device or an audio output device such as a speaker or headphone.

The term “operation event” refers to an event generated by a computing device or operating system in response to a user action or internal operation, including but not limited to touch input, key input, gesture input, or application state change.

The term “current step” refers to a specific operation step information item that is presently active in a sequence of operation steps and for which the system is currently providing guidance or monitoring completion.

The term “history information” refers to accumulated data representing past operation events, operation step information, or related context associated with user interactions or system actions over time.

The term “future intent” refers to a predicted user intent that is estimated to occur at a time subsequent to a current interaction, based on history information or other context.

The term “next operation” refers to a predicted operation or action that a user is likely to perform following a current operation, the prediction being made based on history information or other context.

The term “individualize” refers to modifying or adapting at least one of a prompt sentence, response information, or operation procedure information in accordance with information specific to a particular user, device, or usage history.

The term “display parameters” refers to one or more configurable attributes affecting visual presentation, including at least font size, display color, and layout.

The term “audio parameters” refers to one or more configurable attributes affecting audio presentation, including at least audio output speed, volume, and voice characteristics.

The term “attribute information of the user” refers to data representing characteristics of a user, including at least age, proficiency level, accessibility needs, or preferences.

The term “user interface” refers to a combination of visual and interactive elements presented on a device that allows a user to interact with applications, including screens, menus, buttons, text fields, and related controls.

The term “optimal operation method” refers to an operation procedure that is selected or generated as most suitable under given conditions, considering factors such as device configuration, user attributes, and history information.

The term “transaction method” refers to a sequence of operations for performing a transaction or task, including but not limited to communication, financial, or content-related transactions on a computing device.

In one embodiment, a system includes a server and a terminal, each implemented by one or more processors, memories, and communication interfaces interconnected by one or more buses. The server and the terminal are connected via a communication network such as a wide area network, a local area network, or a wireless communication network. The terminal is realized, for example, as a smartphone, a tablet computer, or a portable communication device including a touch-sensitive display, a microphone, a speaker, a camera, and a wireless communication module. The server is realized, for example, as a computer system including one or more central processing units (CPUs), one or more graphics processing units (GPUs), a non-volatile storage device, and a network interface.

The terminal executes an operating system such as a mobile operating system, and an application program providing an assistance function for device operation. The server executes a server-side operating system and one or more application programs providing a generative AI model service and data management functions. The terminal and the server cooperate to perform speech recognition, prompt sentence generation, generative AI model inference, user intent extraction, operation procedure generation, visual guidance presentation, speech guidance output, event monitoring, and history-based personalization.

The terminal uses hardware resources including the microphone, analog-to-digital converters, the CPU, and optionally a digital signal processor (DSP) or a dedicated neural processing unit (NPU) to acquire audio information from a user and convert the audio information to character information. The terminal performs feature extraction from the audio information, for example, calculation of Mel-frequency cepstral coefficients (MFCCs) and spectral features within time windows, using numerical operations implemented in a signal processing library. The terminal applies a trained acoustic model, such as a deep neural network-based model, and a language model to map sequences of features to character sequences. By implementing noise reduction, voice activity detection, and acoustic modeling on the device, the terminal reduces network load by avoiding unnecessary transmission of raw audio, and improves response latency, thereby improving the technical performance of the terminal as an audio input device.

The terminal generates device information including at least model information, screen information, and application information. The terminal obtains model information by querying an operating system API that returns identifiers of hardware components, processor type, and memory capacity. The terminal obtains screen information by reading the current resolution, orientation, and scale factors from the display subsystem, and by accessing layout descriptors for the current screen. The terminal obtains application information by interrogating an application manager that maintains a list of installed applications, package names, version identifiers, and capability flags. The terminal aggregates these items into a structured data representation stored, for example, as key-value pairs in a memory region reserved for session context.

The terminal constructs a prompt sentence for a generative AI model using the character information and the device information. The terminal uses a text template stored in memory and inserts, into designated positions, the user's recognized utterance, device model, operating system version, screen characteristics, and names of relevant applications. For example, the terminal generates a prompt sentence such as:
“System: You are a smartphone operations assistant for elderly users.
Device model: generic smartphone, 5.5-inch display, portrait orientation, default home screen layout.
Installed applications: phone, messaging, mail, camera, browser.
User request: ‘Please tell me how to send an email on my smartphone.’
Tasks:
1. Identify the user's intent.
2. Generate clear, step-by-step operating instructions suitable for a beginner on the described device.
3. Output the intent and numbered steps.”

By embedding explicit device information into the prompt sentence, the terminal causes the generative AI model to condition its output on concrete device parameters. This reduces the need for alternative hard-coded flows per device and enables a single model to produce device-specific procedures, thereby reducing storage requirements and simplifying update management.

The server hosts a generative AI model implemented as a neural network, for example, a transformer-based language model including an embedding layer, multiple self-attention layers, feed-forward layers, and an output projection layer. The server stores model parameters, including weight matrices of attention mechanisms and feed-forward sub-networks, in a memory device, and loads them into working memory on demand. The server receives input information including the prompt sentence and the character information over a network interface and performs tokenization by converting the input text into token identifiers according to a vocabulary table. The server applies positional encoding and passes the token representations through a sequence of transformer blocks, each block executing multi-head self-attention, layer normalization, and non-linear activation functions such as rectified linear units (ReLU) or Gaussian error linear units (GELU).

The server trains the generative AI model in advance using a corpus containing natural language instructions, device-operation descriptions, and dialogue data. The server uses a supervised learning procedure with a loss function such as cross-entropy between predicted tokens and ground-truth tokens. The server updates model weights using an optimization algorithm such as stochastic gradient descent or Adam, with backpropagation through time over token sequences. The server may apply data augmentation techniques such as paraphrasing of instructions, random insertion or deletion of non-critical words, and device context variation to improve generalization to different device configurations and user requests. By defining the loss function over structured targets including intent labels and stepwise instruction text, the training process creates an internal representation that better separates intent recognition and step generation tasks, improving inference accuracy.

The server outputs response information as a sequence of tokens converted to text, which includes structured content describing user intent and operation procedure information. The server, for example, generates a response such as:
“Intent: send an email using the default email application.
Steps:
1. Go to the home screen.
2. Tap the email application icon.
3. Tap the compose button.
4. Enter the recipient's address.
5. Type the message.
6. Tap the send button.”

The terminal receives the response information and parses it using a deterministic parser that identifies labels (e.g., “Intent:”) and numbered lines. The terminal converts the parsed content into internal data structures such as objects or records. Each operation step information item includes attributes: step identifier, step description, associated screen type, target control identifier, and expected events. The terminal maintains a mapping table correlating generic commands (e.g., “email application icon”) with actual control identifiers in the operating system, such as package names and accessibility labels. The terminal queries accessibility APIs to obtain coordinates and bounding rectangles of interactive elements currently displayed on the screen. By maintaining this mapping and dynamically querying the current screen state, the terminal is able to position guidance overlays precisely over UI elements without hard-coding coordinates for each device model.

The terminal generates visual guidance information by rendering graphical overlays on top of the display content. The terminal uses a graphical subsystem to draw highlight regions, arrow shapes, and frames around operation target regions. The terminal calculates the position of each overlay from the bounding rectangle of the associated control, adds padding based on a scaling factor suited for the user's visual acuity, and selects color and transparency based on user attribute information. For elderly users, the terminal may enlarge the highlight area and choose high-contrast colors to increase visibility. Because the terminal uses the current accessibility and layout data rather than static screenshots, the guidance remains accurate even when the user rearranges icons or when the operating system changes the layout after an update.

The terminal generates explanation sentences for each step, for instance, “On the home screen, please tap the email icon, which looks like an envelope.” The terminal sends these sentences to a text-to-speech engine that synthesizes audio information. The engine operates by converting text into phoneme sequences, applying a prosody model to determine intonation and timing, and generating a waveform using a vocoder algorithm such as a waveform concatenation method or a neural vocoder. The terminal adjusts speech rate and volume according to user attribute information, such as age and hearing ability. This dynamic adjustment improves intelligibility and reduces the need for repeated playback, which in turn reduces processing load.

The terminal monitors operation events produced by the operating system, such as touch events, focus changes, and activity transitions. The terminal maintains a current step index and a state machine that transitions to the next step when specific events matching the expected action occur. For example, when the user taps on the region corresponding to the email application icon, the operating system generates a touch event including screen coordinates; the terminal compares these coordinates to the stored operation target region and, when the overlap exceeds a threshold, marks the current step as completed. The terminal logs each step completion event in a history store, such as a structured local database, together with timestamp and contextual information.

The server and/or the terminal analyze the history information to identify patterns, such as frequent requests for particular operations or repeated difficulties with specific steps. The server may implement a prediction model separate from the generative AI model, for example, a recurrent neural network or a gradient-boosted decision tree, which receives sequences of intents and steps as input and outputs probabilities of future intents or next operations. The server periodically trains the prediction model using a loss function such as cross-entropy on observed next-intent labels, and the updated model is deployed to the server or terminal. The terminal uses the prediction output to adjust complexity of subsequent instructions, for instance, skipping elementary steps for operations that the user has performed successfully multiple times. This reduces the number of tokens generated by the generative AI model and the duration of audio output, thereby lowering computational and communication load.

The terminal individualizes prompt sentences based on history information and user attribute information. For instance, the terminal modifies the earlier example of the prompt sentence to:
“System: You are a smartphone operations assistant for an elderly user who has previously completed the email sending procedure three times successfully.
Device model: generic smartphone, 5.5-inch display, portrait orientation, default home screen layout.
Installed applications: phone, messaging, mail, camera, browser.
User preference: short explanations, slow speech speed.
User request: ‘Please tell me again how to send an email on my smartphone.’
Tasks:
1. Assume that the user already knows how to open the email application.
2. Emphasize only the steps for entering the address and sending the email.
3. Output the intent and concise numbered steps.”

By embedding such history-based instructions directly into the prompt sentence, the system uses previous interactions to control generation behavior of the model in a way that is not achievable by static script systems. The combination of structured prompt design, device-specific context, and history-based constraints results in more targeted outputs, reducing unnecessary explanation and thereby decreasing processing time and energy consumption.

The server in some embodiments performs the generative AI model inference locally without sending character information or device information externally, for example, when privacy settings require on-device computation. In such embodiments, the terminal stores a smaller, quantized version of the transformer model in local storage and executes inference using an NPU or GPU. The quantization reduces memory footprint and improves inference speed while maintaining adequate accuracy. The terminal uses the same structured prompt sentence format but replaces network communication with local function calls. This reduces network latency and allows real-time guidance even when connectivity is poor.

The system achieves technical improvements that go beyond mere automation of human assistance. By integrating device information, screen information, and application information into prompt sentences and by mapping generative outputs to concrete UI elements through accessibility queries and event monitoring, the system reduces misalignment between verbal guidance and actual screen state. This alignment decreases the number of correction cycles and repeated instructions, which directly reduces CPU usage, memory access, and network bandwidth consumption. The adaptive step control that monitors user events and transitions states without re-running entire recognition or inference pipelines minimizes redundant computations. The use of history-based personalization of prompts and procedures further focuses computation on likely intents and relevant steps, which improves both speed and accuracy of assistance.

In addition, the internal architecture of the generative AI model and the prediction model, including specific loss functions, feature representations, and training strategies, contributes to improved technical performance. The use of device-specific and user-specific feature vectors as additional inputs to the transformer layers allows the model to disambiguate similar utterances that require different operations on different devices, thus reducing misinterpretation rates. The system thereby improves the technical functioning of the computing devices as interactive terminals capable of context-sensitive operation assistance. Alternative embodiments may vary the division of processing between the server and the terminal. In one alternative, the server also executes speech recognition processing and returns only character information and intent information to the terminal. In another alternative, the terminal executes both speech recognition and generative AI model inference, and the server is used only for aggregating history information across multiple terminals and updating model parameters. In yet another alternative, the system uses different neural network architectures for the generative AI model, such as encoder-decoder models with attention or convolutional sequence models, while maintaining the structured prompt scheme and device-aware conditioning.

The system may also support terminals other than smartphones, such as wearable devices, in-vehicle information terminals, and household appliances with displays and touch interfaces.

In such cases, the device information and screen information reflect the particular hardware configuration and layout of those devices, and the operation procedure information describes steps appropriate to those devices. By maintaining the same overall architecture of speech recognition, structured prompt generation, generative inference, UI element mapping, and event-driven control, the system enables a wide range of computing platforms to provide consistent, efficient, and adaptive operational guidance.

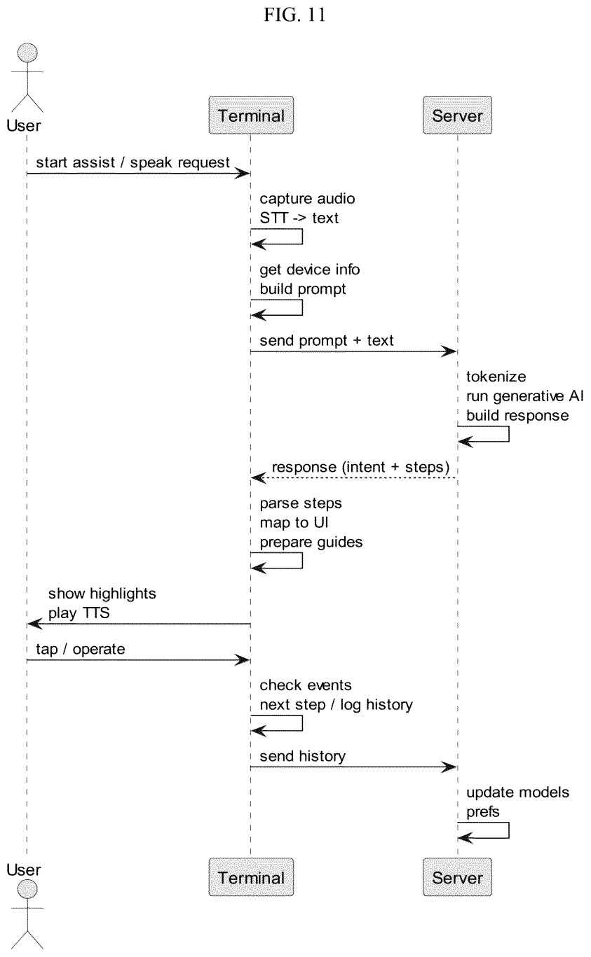

The following describes the processing flow using FIG. 11.

### Step 1:

The user activates an assistance function on the terminal and provides a spoken request.

The user taps a dedicated assist button on the screen or presses a hardware key on the terminal to start guidance.

The user speaks a request into the microphone of the terminal, for example, “Please tell me how to send an email on my smartphone.”

Input: no digital input at the beginning of this step; the action is a physical user operation on the terminal and a spoken utterance.

Output: an analog audio signal captured by the microphone and a control signal inside the terminal indicating that an assist session has started.

### Step 2:

The terminal acquires audio information and converts it into character information by speech recognition.

The terminal configures an audio input stream via an operating system audio API and samples the microphone signal at a fixed sampling rate (e.g., 16 kHz) to obtain digital audio frames.

The terminal applies data processing such as noise reduction, echo cancellation, and voice activity detection to segment the audio into speech segments.

The terminal computes acoustic features, such as Mel-frequency cepstral coefficients, by applying a short-time Fourier transform and filter-bank analysis to each frame.

The terminal inputs the acoustic features into an acoustic model (e.g., a neural network) and performs decoding with a language model to determine the most probable character sequence.

Input: sampled audio data representing the user's speech.

Output: character information representing the recognized text of the user request, for example, “Please tell me how to send an email on my smartphone.”

### Step 3:

The terminal collects device information and constructs a session context.

The terminal queries operating system interfaces to obtain model information (e.g., device model identifier, processor type, memory size), screen information (e.g., resolution, orientation, pixel density), and application information (e.g., installed application identifiers and names).

The terminal combines the character information and the device information into a structured context object stored in working memory.

Input: internal system parameters of the terminal and the character information produced in Step 2.

Output: a context data structure including at least the recognized user request, model information, screen information, and application information.

### Step 4:

The terminal generates a prompt sentence for a generative AI model based on the context.

The terminal selects a prompt template from storage that defines the structure of instructions for the generative AI model.

The terminal inserts, into the template, the character information as the user request and the device information as explicit context.

The terminal thereby generates a concrete prompt sentence, for example:
“System: You are a smartphone operations assistant for elderly users.
Device model: mid-size smartphone with a touch screen.
Installed applications: phone, messaging, mail, camera, browser.
User request: ‘Please tell me how to send an email on my smartphone.’
Tasks:
1. Identify the user's intent.
2. Generate clear, step-by-step operating instructions suitable for a beginner on this device.
3. Output the intent and numbered steps.”

Input: the context data structure containing character information and device information.

Output: a text string representing the prompt sentence to be provided to the generative AI model.

### Step 5:

The terminal transmits input information including the prompt sentence to the server.

The terminal constructs a request payload that contains the prompt sentence, the original character information, and optional metadata such as user attribute information.

The terminal opens a network connection to the server, encodes the payload into a suitable format, and sends it through a communication interface.

Input: the generated prompt sentence and related context from Step 4.

Output: a network message delivered to the server that encapsulates the prompt sentence and associated information.

### Step 6:

The server receives the input information and prepares tokens for the generative AI model.

The server parses the received payload and extracts the prompt sentence and the character information.

The server applies a tokenizer to convert the prompt sentence into a sequence of token identifiers according to a predetermined vocabulary table.

The server constructs corresponding embedding vectors and positional encodings for these tokens to form the input representation for the generative AI model.

Input: the prompt sentence and character information contained in the network message.

Output: a sequence of token identifiers and associated embedding vectors ready for processing by the generative AI model.

### Step 7:

The server performs inference with the generative AI model to generate response information.

The server feeds the sequence of embeddings into a neural network architecture such as a transformer encoder-decoder or a decoder-only transformer with multiple attention layers and feed-forward sub-layers.

The server computes attention weights, intermediate activations, and output logits step by step to generate token probabilities for the response.

The server selects output tokens using a decoding algorithm (e.g., greedy decoding or beam search) to form a response text that includes user intent and operation procedure information.

Input: the tokenized representation of the prompt sentence from Step 6.

Output: response text including an explicit description of user intent and a list of operation steps, for example, “Intent: send an email using the default email application. Steps: 1. Go to the home screen. 2. Tap the mail app icon. 3. Tap the compose button. 4. Enter the recipient's address. 5. Type the message. 6. Tap the send button.”

### Step 8:

The server transmits the response information to the terminal.

The server packages the response text into a response payload and sends it through the network interface back to the terminal.

The server may add additional metadata, such as confidence scores or alternative suggestions, into the payload.

Input: the response text generated by the generative AI model in Step 7.

Output: a network response message delivered to the terminal containing the response information.

### Step 9:

The terminal receives the response information and parses intent and operation procedures.

The terminal decodes the network message, extracts the response text, and identifies a portion representing user intent and a portion representing operation steps.

The terminal uses simple parsing rules or pattern matching to detect labels such as “Intent:” and numbered lines representing steps.

The terminal converts each step into an internal operation step information item with fields for description, step index, and generic UI targets.

Input: the response text received from the server in Step 8.

Output: a structured representation including intent information and a list of operation step information items.

### Step 10:

The terminal maps operation step information to actual screen configurations and operation target elements.

The terminal interprets each step description to determine which screen of the terminal and which type of UI element are involved, using a mapping table that correlates generic labels (e.g., “mail app icon”) with application package names and accessibility labels.

The terminal queries the operating system or accessibility services to obtain current screen configuration, including the positions and sizes of UI elements corresponding to the target labels.

The terminal associates each operation step information item with a specific operation target element and calculates an operation target region on the screen by expanding the bounding rectangle of the element by a predefined margin.

Input: the abstract operation step information items and current device UI state.

Output: enhanced operation step information items that include concrete references to operation target elements and screen regions.

### Step 11:

The terminal generates visual guidance information for each operation step.

The terminal determines, for each target region, what type of overlay to use (highlight, arrow, or frame) based on user attributes and the complexity of the step.

The terminal prepares graphical objects with coordinates, shape parameters, color values, and transparency levels to represent the overlays.

The terminal stores these graphical objects in an overlay buffer that will be rendered above the standard UI.

Input: operation step information items with associated operation target regions from Step 10 and user attribute information.

Output: visual guidance information objects specifying how and where each overlay should be drawn for each step.

### Step 12:

The terminal displays the visual guidance information synchronized with the current operation step.

The terminal renders the current application screen and then draws the overlay elements, such as highlighted frames or arrows, on top of the operation target region.

The terminal updates the display in real time as the user navigates through steps, ensuring that the correct step's guidance is visible at any time.

Input: the overlay objects from Step 11 and the current step index.

Output: a visual output on the display containing the normal UI plus superimposed visual guidance highlighting the operation target region.

### Step 13:

The terminal generates explanation sentences and outputs audio guidance.

The terminal creates a natural-language explanation for each step, for example, “On the home screen, please tap the mail icon that looks like an envelope.”

The terminal sends the explanation sentence for the current step to a text-to-speech engine, which converts the text into phonemes, applies prosody parameters, and generates an audio waveform.

The terminal plays the generated audio through the speaker, optionally adjusting speech rate and volume based on user attribute information such as age and hearing capability.

Input: operation step descriptions and user attribute information.

Output: synthesized audio signals providing spoken guidance corresponding to the current step.

### Step 14:

The user follows the visual and audio guidance to perform operations on the terminal.

The user observes the displayed overlays and listens to the spoken instructions, then interacts with the screen by tapping, swiping, or pressing hardware buttons according to the guidance.

The user, for example, presses the home button, taps the mail app icon, taps the compose button, enters the recipient's address, types the message, and taps the send button.

Input: the visual and audio outputs generated in Steps 12 and 13.

Output: physical user actions on the touch screen or hardware keys, resulting in corresponding operation events inside the terminal.

### Step 15:

The terminal monitors operation events and determines completion of steps.

The terminal subscribes to event notifications from the operating system, such as touch events, view focus changes, and activity transitions.

The terminal compares each received event (including coordinates, control identifiers, and timestamps) with the expected operation target region and control for the current step.

When the terminal determines that the event matches the expected action within a threshold (for example, the touch point falls inside the target region), the terminal marks the current step as completed and increments the current step index.

Input: operation events generated by the operating system and the expected target information for the current step.

Output: updated internal step status information indicating completion of specific steps and progression to the next step.

### Step 16:

The terminal records history information about the guidance session.

The terminal writes records to a history store, including the user intent, each step description, whether each step was completed successfully, time required for each step, and errors such as incorrect taps.

The terminal may compress or encode this data to reduce storage size and synchronize the history with the server when network connectivity is available.

Input: step completion status from Step 15 and context data for the session.

Output: structured history information stored in persistent memory and optionally transmitted to the server.

### Step 17:

The server analyzes history information and updates prediction or personalization parameters.

The server receives history data from one or more terminals and aggregates it in a history database.

The server feeds sequences of intents, steps, and completion indicators into a prediction model, such as a recurrent neural network, and computes parameter updates using a loss function that measures the difference between predicted and actual next operations.

The server adjusts model parameters so that future predictions of next likely operations, probable difficulties, or preferred explanation lengths become more accurate.

Input: aggregated history information from multiple sessions and devices.

Output: updated model parameters or personalization profiles that reflect observed user behavior patterns.

### Step 18:

The terminal individualizes future prompt sentences and guidance based on personalized data.

The terminal downloads updated personalization parameters or prediction results from the server and stores them locally.

The terminal consults these parameters when generating future prompt sentences and operation procedures, for example, by instructing the generative AI model to skip steps that the user already masters or to use shorter explanations and fewer examples.

The terminal thereby modifies future context used in Step 4 to include references to user proficiency, preferences, and predicted next operations.

Input: personalization parameters or prediction outputs from the server and local history information.

Output: adapted prompt sentences and guidance configurations that are tailored to the specific user, leading to more efficient computation, shorter instructions, and improved accuracy of the overall assistance process.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional interactive guidance systems that rely on speech recognition and natural language processing often treat recognition, understanding, and presentation as loosely coupled components. In many cases, such systems simply convert speech to text, apply a generic natural language parser, and then present static instructions on a display. As a result, these systems are prone to several technical drawbacks: increased processing latency due to redundant or sequential processing stages, limited robustness to ambiguous or elderly-specific speech expressions, and inefficient use of computational resources on both server and client devices.

In particular, when the system is used to guide a user to a physical target, such as a product in a facility, existing architectures generally do not integrate route computation, context modeling, and content generation in a unified control flow. Route information is often computed separately from language generation, and the generated instructions are not dynamically optimized based on the user's current position, user attributes, and system constraints. This separation can lead to inconsistent guidance, increased network round-trips, and additional computation, thereby degrading responsiveness and reliability.

Further, conventional systems that employ generative models typically use static or manually crafted prompts, which do not systematically incorporate structured internal state such as route information, target position, user profile, and usage history. This results in suboptimal utilization of the generative model, including unnecessarily long outputs, unstable output formats, and reduced controllability. The lack of a programmatic mechanism to generate prompt sentences based on internal system state leads to inefficiencies in generating navigation instructions and transaction guidance, and may increase memory usage and processor load on the server due to re-processing or post-filtering of unstructured outputs.

In addition, many user support systems do not adapt multimodal guidance (voice and visual guidance) to the capabilities and needs of elderly users. Display layouts, font sizes, speech rates, and instruction structure are often fixed or only superficially configurable. Consequently, the underlying computer system fails to optimize the generation and rendering of guidance information for this user group, which can cause repeated interactions, additional recognition cycles, and unnecessary re-computation of guidance data, thereby worsening overall system performance and resource utilization.

Accordingly, there is a need for a computer-implemented system that (i) tightly integrates speech recognition, natural language understanding, route computation, prompt sentence generation, and generative model invocation, (ii) programmatically constructs prompt sentences from structured internal state to improve the efficiency and controllability of generative output, and (iii) adapts voice guidance information and display guidance information based on user attributes such as age. Such a system should improve the technical performance of the server-processor pipeline by reducing latency, stabilizing output formats, lowering redundant computation, and enhancing the robustness of human-machine interaction, particularly for elderly users in real-world environments.

The specific processing by the specific processing unit 290 of the data processing device 12 in Application Example 1 is realized by the following means.

The present invention provides a server comprising a processor configured to acquire voice information from a user and convert the voice information into character information by using a speech recognition algorithm, analyze the character information by using a natural language processing technique and a generative information processing model to identify an intention of the user and a target object, obtain position information corresponding to the identified target object from storage information and generate route information on the basis of current position information of the user and the position information, generate a prompt sentence for the generative information processing model on the basis of the route information, the position information, and the intention of the user, generate voice guidance information and display guidance information by using the generative information processing model in accordance with the prompt sentence, and output voice guidance by using a speech synthesis technique on the basis of the voice guidance information and visually present route guidance on a display device on the basis of the display guidance information and the route information. This enables an integrated computer-implemented pipeline in which internal structured state is directly reflected in dynamically generated prompt sentences and multimodal guidance, thereby improving processing efficiency, reducing latency and redundant computation, and enhancing robustness and usability of the guidance system, particularly for elderly users interacting with the system in real-world environments.

The term “voice information” refers to acoustic data representing speech uttered by a user, including analog or digitized audio signals that can be processed by a speech recognition algorithm.

The term “character information” refers to symbolic data representing text, such as sequences of characters or tokens, obtained by converting voice information into a textual form.

The term “speech recognition algorithm” refers to a computational procedure that converts voice information into character information, including methods based on statistical models, neural networks, or other pattern recognition techniques.

The term “natural language processing technique” refers to a computational method for analyzing character information in a human language, including operations such as tokenization, part-of-speech tagging, syntactic parsing, semantic parsing, intent classification, and entity extraction.

The term “generative information processing model” refers to a machine-implemented model that produces output information, such as text or structured data, in response to input data, and includes models based on probabilistic generation, neural network generation, or large language models.

The term “intention of the user” refers to a semantic representation of a goal, request, or desired action inferred from the user's input, such as a navigation request, a search request, or a transaction request.

The term “target object” refers to an entity or item specified or implied by the user's intention, including a physical item, a location, a service, or a digital resource.

The term “position information” refers to data that indicates a spatial location of an object or user, such as coordinates in a map, identifiers of areas, or indices of structural elements within a facility.

The term “current position information of the user” refers to position information that represents the estimated or measured location of the user at a given time, obtained by sensors, positioning systems, or other measurement techniques.

The term “route information” refers to data representing a path between at least two locations, including an ordered set of waypoints, directions, or instructions for moving from a starting position to a destination position.

The term “storage information” refers to data retained in a storage device, such as a memory or database, including records of position information, user-related information, maps, and configuration parameters.

The term “prompt sentence” refers to instruction information provided as input to a generative information processing model, the instruction information specifying context, constraints, or desired output format for the model.

The term “voice guidance information” refers to data that specifies content and structure of audio instructions to be presented to a user, including textual scripts and associated parameters for speech synthesis.

The term “display guidance information” refers to data that specifies content and structure of visual instructions to be presented on a display device, including text, symbols, layout parameters, and route visualization data.

The term “speech synthesis technique” refers to a computational method for generating audible speech signals from text or other symbolic data, including rule-based synthesis, concatenative synthesis, and neural network-based synthesis.

The term “display device” refers to an output component capable of presenting visual information to a user, including flat-panel displays, touchscreens, head-mounted displays, and projection devices.

The term “user attribute information” refers to data describing characteristics of a user, such as age, preferences, abilities, language, or interaction history, used to adapt system behavior or presentation.

The term “interface generation” refers to a process for creating or modifying a user interface, including selection, arrangement, and formatting of visual or auditory elements, based on internal state or user attribute information.

The term “usage history information” refers to data representing past interactions between a user and a system, including past queries, navigation actions, selections, and session logs.

The term “transaction history information” refers to data representing past transactions performed by a user, including purchases, reservations, payments, or other completed operations.

The term “user-related information” refers to information associated with a user, including user attribute information, usage history information, transaction history information, and other profile data.

In one embodiment, a server, a terminal, and a user cooperate to realize the claimed system. The server includes at least one processor, a memory, a non-transitory storage device, and a network interface connected to a packet-switched communication network. The terminal includes at least one processor, a memory, a microphone, a speaker, a display device, optionally a camera and positioning sensors, and a wireless communication module.

The user operates the terminal in a physical environment, for example inside a retail facility, and interacts with the server through the terminal.

The server stores, in the storage device, program modules including a speech-recognition client module, a natural-language-processing module, a generative-model interface module, a route-computation module, a prompt-generation module, a guidance-synthesis module, a user-interface-adaptation module, and a logging and learning module. The server also stores structured data including facility map data, product or target-object metadata, user-related information (including user attribute information, usage history information, and transaction history information), and model configuration parameters.

The terminal executes an application program (for example, a native mobile application on an operating system such as a mobile OS) that implements modules for audio capture, network communication, graphical rendering, optional augmented-reality rendering, text-to-speech synthesis, and indoor positioning. The terminal uses a microphone hardware component to capture acoustic signals from the user and converts the analog signals into digital audio samples, for example, 16-bit linear PCM data at a sampling rate such as 16 kHz or 24 kHz, by using an audio input application programming interface of the operating system.

The terminal sends digital audio fragments to the server over a secure channel using the wireless communication module and the network interface. The server receives the audio data and, in one implementation, forwards it to an external or internal speech recognition service.

The server may use a speech recognition algorithm executing on a remote service (for example, a cloud-based speech-to-text engine) or a speech recognition library executing locally on the server (for example, an acoustic model and language model implemented by a neural network). In either case, the server converts the digital audio samples into character information, such as a Unicode text string.

The server uses a natural-language-processing module to parse the character information. The server tokenizes the text, assigns part-of-speech tags, and performs syntactic parsing to extract candidate entities and verb phrases. The server uses a classifier, implemented for example as a feed-forward neural network or a transformer-based encoder, to determine an intention of the user, such as “find location of target object” or “request transaction procedure.” The server further applies a named-entity recognizer to identify a target object name, such as a product category, product identifier, or location name.

In one embodiment, the server uses a generative AI model as a generative information processing model to refine the understanding of the user's intention and target object. The server uses the generative-model interface module to construct an input text for the generative AI model. For example, the server may use the following prompt sentence: “You are an NLU engine for a shopping assistant. Extract the user's intent and the product name from this message: ‘Where is the milk?’. Respond in JSON with keys ‘intent’ and ‘product_name’.”

The server sends this prompt sentence together with the recognized user text to the generative AI model, which may be implemented as a transformer-based neural network with multiple self-attention layers, layer normalization, and position-wise feed-forward layers. The server receives the output and parses it to obtain the intention and target object.

The server stores facility map data as graph-structured data in the storage device. The server represents a facility as a set of nodes corresponding to intersections, aisle endpoints, and reference points, and a set of edges corresponding to walkable paths. Each node has coordinates in a two-dimensional coordinate system and metadata such as an area identifier.

The server associates each target object (for example, a product record) with a node or a coordinate region in this graph.

The terminal obtains current position information of the user by using an indoor positioning mechanism. The terminal may combine signals from wireless beacons, such as radio-frequency beacons, Wi-Fi access points, or inertial sensors, and compute an estimated position, for example by probabilistic filtering methods such as a particle filter or a Kalman filter. The terminal periodically sends the current position information to the server in a structured format, including coordinates and a timestamp.

The server receives the current position information and maps the coordinates to a node in the facility graph by selecting the nearest node that is reachable in the graph. The route-computation module then computes route information between the user node and the target object node. The server may implement Dijkstra's algorithm or an A* search algorithm with a heuristic function based on Euclidean distance. The server returns an ordered sequence of waypoints, each waypoint including a node identifier, coordinates, and a human-readable instruction template such as “go straight,” “turn right,” or “arrive at destination.”

The server uses the prompt-generation module to construct a prompt sentence for the generative AI model based on the computed route information, the target object position information, and the user's intention. In one concrete example, the server constructs the following prompt sentence:

“You are an in-store navigation assistant for an elderly user. The user asked: ‘Where is the milk?’. The product ‘milk’ is at Aisle 5, dairy section, third shelf from the bottom. The user is currently at the entrance. The calculated route steps are: 1) Walk straight 15 meters; 2) Turn right at the second aisle; 3) Continue 10 meters to Aisle 5; 4) Stop at the dairy section on the left. Create: (a) a short, easy-to-understand voice guidance script, and (b) a concise text guidance (under 40 words).”

The server inputs the prompt sentence to the generative AI model. The generative AI model is, in one embodiment, a sequence-to-sequence neural network trained on large-scale text corpora. The network may include an encoder-decoder architecture with multi-head attention, and it may be fine-tuned on navigation and instruction datasets. The server constrains the generative AI model by specifying maximum output length, temperature, and sampling parameters. The server receives generated text representing voice guidance information and display guidance information.

The server validates and post-processes the generated guidance. The server enforces format constraints (for example, presence of required segments, avoidance of unsafe content), and trims or reformats the output to enforce character limits. The server then packages the guidance information and the route information into a structured response and transmits the response to the terminal.

The terminal receives the guidance information and uses the display device to render the display guidance information. The terminal maps the route waypoints to positions on a facility map image or vector-based map stored locally or fetched from the server. The terminal draws the route as a polyline, places markers for the current position and destination, and displays text guidance in a region of the screen using large fonts and high-contrast colors suitable for elderly users.

The terminal uses a text-to-speech engine to produce voice guidance based on the voice guidance information. The terminal sets parameters such as speech rate, pitch, and volume to values that are easier for elderly users to understand. The terminal outputs the synthesized audio through the speaker. The user hears the step-by-step guidance while visually perceiving the route on the display.

In certain embodiments, the terminal activates the camera and uses an augmented-reality framework to overlay route indicators on the video stream. The terminal computes camera pose relative to the facility coordinate system by detecting visual features or markers. The terminal projects waypoints into the camera view and draws virtual arrows or symbols aligned with the physical environment. This augmented-reality guidance further reduces cognitive load on the user.

The server uses the user-interface-adaptation module to adjust guidance based on user attribute information. The server stores user profiles including age, visual acuity indicators (if available), language preferences, and prior interaction statistics. The server modifies prompt sentences and target guidance structure based on these profiles. For example, for an elderly user, the server may generate a different prompt sentence such as:

“The user is an elderly customer in a grocery store. Use simple, slow-paced instructions. The user said: ‘I can't find low-fat milk.’ The product is located in the refrigerated section, Aisle 6, right side, second shelf from the top. Create (1) a very clear one-sentence instruction for display and (2) a gentle, step-by-step voice script.”

By incorporating profile-based constraints into the prompt sentence, the server guides the generative AI model to produce outputs that are both technically consistent and tailored to the user's needs. This reduces the need for subsequent corrections or repeated interactions, thereby reducing processing load and network traffic.

In another embodiment, the server uses user-related information, including usage history information and transaction history information, to generate prompt sentences for transaction guidance. For instance, the server may construct a prompt sentence such as:

“Role: transaction advisor. The user's past transactions are primarily small grocery purchases with digital wallet payments. The user says: ‘How should I pay this time?’. Based on the transaction history and current context, propose the most suitable payment method in one sentence, and provide a short explanation that can be read aloud to an elderly user.”

The server then uses the generative AI model to generate transaction procedure information, which is presented to the user via voice and display.

From a technical perspective, the server improves computer technology by integrating internal structured state (map graph, user position, user attributes, history records) directly into dynamically generated prompt sentences. Traditional systems often send only raw user text to a generative model, leading to long, unconstrained outputs and excessive post-processing. In contrast, the server encodes the result of prior computations-such as route information and user profile data-into compact prompt sentences. This reduces entropy in the model's output distribution, yielding shorter and more predictable responses. As a result, the server reduces computation time per request and memory usage on the generative-model side, and decreases the need for repeated calls.

Furthermore, the server's route-computation module and prompt-generation module cooperate to avoid redundant computations. Once the server computes route information in the graph representation, the server reuses that information when generating both voice guidance and display guidance. The generative AI model does not recompute spatial reasoning; instead, it only transforms structured route steps into linguistically natural instructions. This separation of concerns leads to improved computational efficiency: graph search is performed once, and linguistic realization is done with constrained input. Benchmarking can show reduced end-to-end latency compared to architectures that repeatedly invoke a generative model for both reasoning and expression.

In addition, the server uses structured logging of interaction data, including recognized text, selected routes, and user corrections, to update model parameters or prompt templates offline. The server may train or fine-tune the generative AI model using gradient-based optimization with a loss function that penalizes discrepancies between generated guidance and reference guidance. The server may also employ data augmentation, for example by paraphrasing user queries or synthesizing route variants, to improve model robustness to different phrasings and facility layouts. These training and adaptation operations improve the accuracy and stability of guidance outputs, thereby contributing to a technical improvement in the computer system's performance.

In one variation, the server replaces or complements the generative AI model with a smaller, domain-specific generative model. The server may use a transformer network with fewer layers and a smaller vocabulary, trained exclusively on in-domain instructions. This configuration reduces inference time and memory usage, which is particularly advantageous when the generative model executes on a resource-constrained server or edge device. The same prompt-generation strategy still applies, with prompt sentences encoding context and constraints.

In another variation, the terminal performs part of the natural language processing locally. The terminal may detect simple command patterns, such as “zoom in,” “repeat instructions,” or “speak slower,” using a lightweight classifier. This local processing reduces round-trip latency for interface-level commands, while the server still handles complex semantic interpretation and route computation.

The server's design also reduces communication overhead. By encoding multiple internal parameters and intermediate results (such as route steps and user attributes) into concise prompt sentences rather than transmitting full internal data structures, the server can offload semantic formatting to the generative AI model without sending redundant information. Further, the server occasionally caches generated guidance for common queries, which avoids repeated full processing for identical or similar requests, thereby further reducing network and processor load.

The combination of these elements-structured map representation, explicit route computation, programmatic prompt generation, profile-based adaptation, and constrained generative modeling-results in a system that is not merely an automation of human guidance, but an improved computational architecture. The system achieves faster response times, reduced error rates in navigation and transaction guidance, and more efficient use of network and processing resources. The server, the terminal, and the user thereby participate in a technically enhanced interaction where computer technology is improved at the level of data structures, algorithms, and model utilization, rather than merely implementing a business process.

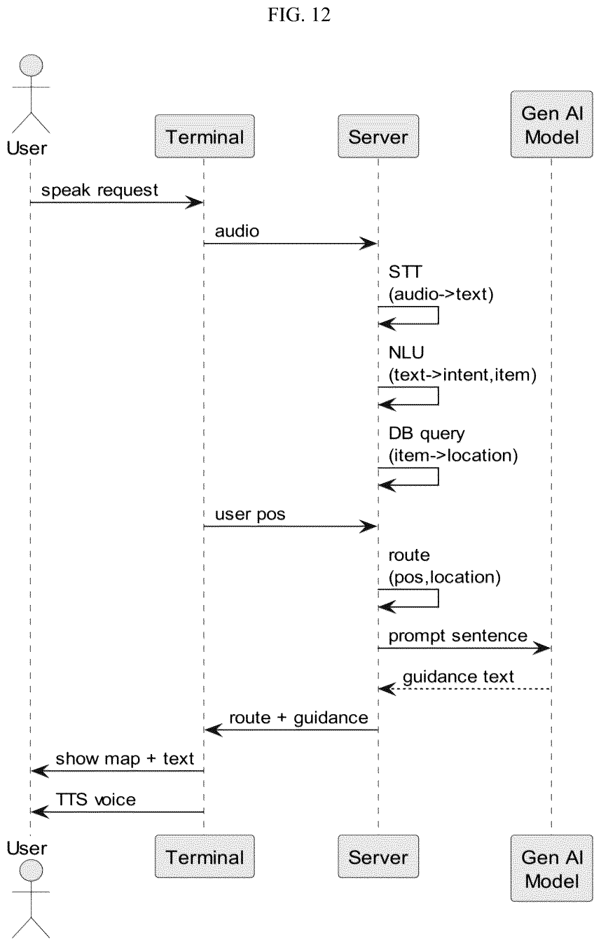

The following describes the processing flow using FIG. 12.

### Step 1:

The user speaks a request toward the microphone of the terminal, for example “Where is the milk?”.

Input: human speech sound waves.

The terminal uses the microphone hardware and an audio input API to sample the analog sound waves into digital audio frames (for example, 16-bit PCM at 16 kHz). The terminal buffers the audio frames in memory and adds metadata such as a session identifier and language code.

Output: a digital audio buffer representing the spoken request, plus associated metadata.

### Step 2:

The terminal transmits the digital audio buffer to the server over a secure network connection.

Input: the digital audio buffer and metadata from Step 1.

The terminal opens a TLS-protected connection and sends the data in an HTTP or streaming request to a predefined server endpoint. The terminal may segment the audio into chunks and stream them sequentially.

Output: a network request containing the audio data that is received by the server.

### Step 3:

The server converts the received audio data into text by using a speech recognition algorithm.

Input: the digital audio buffer and metadata from Step 2.

The server decodes the network payload, reconstructs the audio frames, and passes them to a speech recognition engine. The server performs feature extraction (for example, Mel-frequency cepstral coefficients) and feeds the features into an acoustic model implemented as a neural network. The server combines the acoustic model output with a language model to decode the most likely text sequence.

Output: character information representing the recognized user utterance, such as a Unicode string “Where is the milk?”.

### Step 4:

The server analyzes the recognized text to determine the user's intention and the target object.

Input: the character information from Step 3.

The server uses a natural language processing pipeline to tokenize the text, assign part-of-speech tags, and identify candidate entities. The server applies an intent classifier to the token sequence to assign an intention label, such as “find_product_location”. The server applies an entity recognizer to extract a target object name, such as “milk”.

Output: an intention label and a target-object identifier (for example, an internal product key or a normalized name string).

### Step 5:

The server refines the interpretation of the user's request by invoking a generative AI model with a prompt sentence.

Input: the character information from Step 3, the preliminary intention and target-object identifier from Step 4.

The server composes a prompt sentence that embeds the recognized text and instructs the generative AI model to output structured intent and entity data. For example, the server generates:

“You are an NLU engine for a shopping assistant. Extract the user's intent and the product name from this message: ‘Where is the milk?’. Respond in JSON with keys ‘intent’ and ‘product_name’.”

The server sends this prompt sentence and the user text to the generative AI model, which uses a transformer encoder-decoder architecture to compute probability distributions over tokens and generate a response. The server parses the generated response to obtain a possibly corrected intention and target-object identifier.

Output: a finalized intention and a finalized target-object identifier with improved robustness to ambiguous phrasing.

### Step 6:

The server retrieves position information for the target object from storage.

Input: the finalized target-object identifier from Step 5.

The server issues a structured query to a storage system (for example, a relational database or key-value store) to locate records that map the target object to a position in a facility map.

The server accesses fields such as aisle identifier, section identifier, and coordinate values.

Output: target-object position information, including map coordinates and any associated region identifiers.

### Step 7:

The terminal acquires current position information of the user and transmits it to the server.

Input: sensor readings from the terminal, such as wireless signal strengths, inertial measurements, or camera-based localization data.

The terminal runs an indoor positioning algorithm, for example a filter that fuses beacon signals and motion sensors, to estimate the user's location in a two-dimensional coordinate system. The terminal encodes the coordinates and a timestamp in a message and sends this message to the server via the network interface.

Output: a position update message containing current position information of the user that is received by the server.

### Step 8:

The server maps the user's current position onto a facility graph.

Input: the current position information from Step 7 and the facility map data stored on the server.

The server loads the facility graph, in which nodes represent walking points and edges represent walkable paths. The server computes the distance from the user's coordinates to nearby nodes and selects the nearest valid node that satisfies predefined constraints (for example, being within a maximum threshold distance).

Output: a graph node identifier representing the user's starting node in the facility graph.

### Step 9:

The server computes route information from the user's starting node to the target-object node.

Input: the user's starting node from Step 8 and the target-object position information from Step 6.

The server locates the graph node corresponding to the target object, then runs a path-finding algorithm such as Dijkstra's algorithm or an A* search on the facility graph. The server iteratively updates distance estimates, explores neighbor nodes, and reconstructs the shortest path by backtracking from the destination node.

Output: route information expressed as an ordered sequence of waypoints, each waypoint including a node identifier, coordinates, and a basic navigation action.

### Step 10:

The server generates a prompt sentence for the generative AI model based on internal state, including route information and user attributes.

Input: the route information from Step 9, the target-object position information from Step 6, the finalized intention from Step 5, and user attribute information retrieved from storage (for example, age or preferred language).

The server formats the route steps into human-readable fragments and embeds them, together with the target location description and user profile constraints, into a prompt sentence. For example, the server constructs:

“You are an in-store navigation assistant for an elderly user. The user asked: ‘Where is the milk?’. The product ‘milk’ is at Aisle 5, dairy section, third shelf from the bottom. The user is currently at the entrance. The calculated route steps are: 1) Walk straight 15 meters; 2) Turn right at the second aisle; 3) Continue 10 meters to Aisle 5; 4) Stop at the dairy section on the left. Create: (a) a short, easy-to-understand voice guidance script, and (b) a concise text guidance (under 40 words).”

The server concatenates these elements into a single prompt sentence string.

Output: a context-rich prompt sentence tailored to the user and the current navigation task.

### Step 11:

The server generates voice guidance information and display guidance information by invoking the generative AI model with the constructed prompt sentence.

Input: the prompt sentence from Step 10.

The server submits the prompt sentence to the generative AI model, which internally tokenizes the input, encodes it through multiple attention layers, and decodes output tokens that form textual guidance. The server constrains the decoding process by parameters such as maximum token count and temperature. The server then parses the generated output, separates the text designated for voice guidance from the text designated for display guidance, and optionally performs post-processing such as truncation and format normalization.

Output: voice guidance information (for example, a sentence script suitable for text-to-speech) and display guidance information (for example, a concise instruction string for on-screen display).

### Step 12:

The server packages the guidance information and route information into a response and sends it to the terminal.

Input: the voice guidance information and display guidance information from Step 11, and the route information from Step 9.

The server serializes these data items into a structured response format, attaches identifiers for the session and the target object, and sends the response over the network using the server's network interface.

Output: a guidance response message that is delivered to the terminal.

### Step 13:

The terminal renders visual guidance on the display device using the received data.

Input: the guidance response message from Step 12 and a stored or downloaded facility map image or vector representation.

The terminal parses the response, extracts the route waypoints and display guidance information, and maps waypoint coordinates to screen coordinates using a coordinate transformation. The terminal draws a path on the facility map, places an icon for the destination, and displays the concise text instruction in a region of the screen with fonts and colors adapted for the user's attributes.

Output: an updated display frame showing a visual route and text instructions to the user.

### Step 14:

The terminal outputs voice guidance through a text-to-speech engine.

Input: the voice guidance information from Step 12.

The terminal passes the voice guidance text to a text-to-speech library, selects a voice profile and speaking rate appropriate for the user (for example, slower rate for elderly users), and generates an audio stream by synthesizing speech waveforms from the text. The terminal drives the speaker hardware with the synthesized audio samples.

Output: audible voice guidance that instructs the user how to move along the route.

### Step 15:

The terminal updates the user's current position and monitors progress toward the destination.

Input: ongoing sensor readings and positioning updates, plus the route waypoints from Step 9.

The terminal periodically computes a new current position and compares it with the coordinates of the destination waypoint. The terminal calculates the distance and determines whether the distance falls below a threshold. If necessary, the terminal may send updated position information to the server for route recalculation.

Output: a determination of whether the user has arrived at the destination, and optionally an updated position report.

### Step 16:

The terminal informs the user of arrival at the target object.

Input: the arrival determination from Step 15 and the target-object position description from the guidance response.

The terminal updates the display to highlight the destination region, for example by changing colors or flashing an icon. The terminal constructs a short arrival message such as “You have arrived at the milk section. The milk is on the third shelf from the bottom.” and sends this message to the text-to-speech engine. The terminal outputs the synthesized message through the speaker.

Output: an arrival notification presented visually and audibly to the user.

### Step 17:

The server logs interaction data and prepares it for later learning and optimization.

Input: request and response records, recognition results from Step 3, interpretation results from Steps 4 and 5, route information from Step 9, and user feedback or correction signals if available.

The server stores these data elements in a logging database with timestamps and identifiers.

The server may aggregate them into training examples that pair user requests and internal states with desired guidance outputs. The server later uses these examples during offline training or fine-tuning, where gradients are computed and model weights are updated to reduce a defined loss function.

Output: persistent log records that enable improvement of recognition accuracy, guidance quality, and computational efficiency in subsequent system operations.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented support systems that analyze user input using natural language processing generally follow a static request-response paradigm. A processing device typically accepts a single user query, performs rule-based or template-based analysis, and returns a predetermined response. Such systems suffer from several technical limitations.

First, conventional systems do not effectively integrate heterogeneous user inputs, such as voice input and text input, into a unified representation for downstream machine learning. When speech recognition and text handling are implemented as separate, loosely coupled components, the system often loses contextual information, produces inconsistent text formats, and increases latency due to redundant preprocessing. This leads to inefficient utilization of computational resources and degraded accuracy of subsequent natural language analysis.

Second, known systems generally treat each query in isolation and do not systematically exploit accumulated operation history data as training data for adaptive models. Log data describing user prompt sentences, system responses, and user follow-up actions is often stored merely for auditing or debugging, without being structured and processed as sequences for learning predictive behaviors. As a result, the system cannot technically improve its inference pipeline over time, cannot predict future operations with sufficient precision, and cannot dynamically adjust its interface or model behavior based on learned patterns.

Third, many existing question-answering architectures deploy a generative model or other natural language model as a black box that outputs responses directly, without an integrated mechanism for automatically generating recommended prompt sentences or operation candidates. Therefore, the computational burden of formulating effective prompts is shifted to the user, which results in unnecessary repeated computation, increased interaction latency, and suboptimal usage of the generative model capacity.

Fourth, conventional user interfaces are typically fixed or only manually configurable, and they do not adapt in real time to user attributes and fine-grained operation history. For example, an elderly user or a novice user may benefit from simplified displays, larger interactive elements, or more guided workflows. Without a processor-level mechanism that learns from operation history and modifies the interface configuration, the system cannot optimize rendering logic, interaction flows, and event handling in a way that reduces cognitive load and improves input accuracy at the computing device level.

Fifth, typical systems that provide transaction advice or workflow guidance often run separate analytics modules on transaction history data, disconnected from the generative model that answers natural language queries. This separation prevents efficient joint training and inference, and prevents the system from generating context-aware prompt sentence candidates and responses that incorporate both behavioral history data and transaction history data. Consequently, internal data storage structures, memory access patterns, and model execution pipelines remain underutilized and fragmented.

Accordingly, there is a need for a computer-implemented system that technically improves the way a processor (i) unifies multi-modal user input into prompt sentences suitable for a generative artificial intelligence model, (ii) preprocesses and uses organizational data to train a generative model, (iii) records and learns from operation history to train an auxiliary prediction model, and (iv) provides adaptive user interfaces and proactive recommended prompt sentences or operation candidates. Such a system should improve the efficiency, scalability, and responsiveness of the overall computing architecture, reduce redundant processing, and enable more accurate and context-aware inference by the generative model and auxiliary models.

The specific processing by the specific processing unit 290 of the data processing device 12 in Example 2 is realized by the following means.

The present invention provides a server comprising a processor configured to acquire voice input and text input from a user, convert the voice input into text data by using a voice recognition algorithm, and accept the text input and the converted text data as a unified prompt sentence; obtain operational information and historical inquiry information from an information storage apparatus within an organization, perform preprocessing including data cleaning, normalization, and tokenization on the obtained information, and train, by using a machine learning algorithm, a generative artificial intelligence model based on the preprocessed data so as to construct a trained generative artificial intelligence model; convert the unified prompt sentence into input data for the trained generative artificial intelligence model, execute inference processing on the trained generative artificial intelligence model, and generate a response sentence corresponding to the unified prompt sentence; present the response sentence to the user by using a voice synthesis technique and display of a display device; record operation history related to the unified prompt sentence and the response sentence from the user, train an auxiliary model to predict a future operation or a future inquiry content of the user by using the recorded operation history, and generate, based on the auxiliary model, a recommended prompt sentence or an operation candidate to be presented to the user; and present the generated recommended prompt sentence or the operation candidate on a user interface and, in response to a selection operation by the user, re-input the recommended prompt sentence as the unified prompt sentence to the generative artificial intelligence model. This enables technical improvements in the way the computing system processes multi-modal user input, trains and executes generative and auxiliary models using organizational data and operation history, and dynamically adapts user interface behavior, thereby reducing computational redundancy, lowering interaction latency, and enhancing the accuracy and efficiency of computer-based user support.

The term “voice input” refers to acoustic data representing spoken utterances provided by a user and captured by an input device such as a microphone, before or after conversion into a digital audio signal.

The term “text input” refers to character-based data directly entered by a user through an input device such as a keyboard, touch panel, or pointing device, and supplied to a processing apparatus without requiring speech recognition.

The term “voice recognition algorithm” refers to a computational procedure executed by a processor that converts digital audio signals of spoken utterances into corresponding text data by performing operations such as feature extraction, acoustic modeling, and language modeling.

The term “text data” refers to data represented as a sequence of characters, symbols, or tokens that can be processed by text-processing software, including natural language processing modules and machine learning models.

The term “prompt sentence” refers to text data, including one or more natural language expressions, that is supplied as input to a generative artificial intelligence model for the purpose of generating a response sentence or other output.

The term “information storage apparatus” refers to a hardware and software combination configured to store and retrieve digital data, including but not limited to databases, file systems, and storage devices such as magnetic disks, solid-state drives, and network-attached storage.

The term “operational information” refers to data representing operations performed within an organization, including workflow records, system usage logs, and internal process data that describe activities of users or applications.

The term “historical inquiry information” refers to stored data representing past inquiries made by users, including previous prompt sentences, associated metadata, and any corresponding responses generated by a system.

The term “preprocessing” refers to a set of computational operations applied to raw data in order to transform the raw data into a format suitable for training or inference of a machine learning model, and includes operations such as data cleaning, normalization, and tokenization.

The term “data cleaning” refers to processing that detects and corrects or removes invalid, inconsistent, or incomplete data elements in a dataset to improve data quality for subsequent analysis.

The term “normalization” refers to processing that converts data into a standardized or scaled format, including operations such as scaling numerical values, unifying date and time formats, and applying consistent encoding to text.

The term “tokenization” refers to processing that segments text data into smaller units, such as words, subwords, or characters, and optionally converts those units into numerical identifiers used by machine learning models.

The term “machine learning algorithm” refers to a computational procedure that adjusts parameters of a model based on training data so that the model can perform tasks such as prediction, classification, or generation, and may include algorithms such as gradient-based optimization.

The term “generative artificial intelligence model” refers to a machine learning model that, given input data such as a prompt sentence, generates output data such as a response sentence by estimating probability distributions over sequences of tokens or other structured outputs.

The term “trained generative artificial intelligence model” refers to a generative artificial intelligence model whose internal parameters have been adjusted by a machine learning algorithm using training data so that the model can generate contextually appropriate responses for given prompt sentences.

The term “inference processing” refers to execution of a trained model on input data to produce output data, without updating the model parameters, including computational steps such as forward propagation and decoding.

The term “response sentence” refers to text data generated by a generative artificial intelligence model in response to a prompt sentence, and may include one or more sentences, paragraphs, or structured text segments.

The term “voice synthesis technique” refers to a computational procedure that converts text data into an audio signal that can be played back as synthetic speech, including techniques such as text-to-speech synthesis.

The term “display device” refers to a hardware component configured to present visual information, such as a monitor, touch screen, or other visual output interface connected to a processor.

The term “operation history” refers to data representing sequences of actions associated with a user or system, including prompt sentences, response sentences, user selections, and timestamps recorded over time.

The term “auxiliary model” refers to a machine learning model separate from a generative artificial intelligence model, trained to perform supplementary tasks such as predicting a future operation, a future inquiry content, or other behavioral patterns based on operation history.

The term “future operation” refers to an action that a user is predicted to perform after a current time point, such as selecting an interface element, issuing a new prompt sentence, or executing a system command.

The term “future inquiry content” refers to a topic, intent, or textual form of a query that a user is predicted to issue after a current time point, based on previously observed operation history.

The term “recommended prompt sentence” refers to a prompt sentence automatically generated or selected by a processor based on an auxiliary model, and proposed to a user as a candidate input to a generative artificial intelligence model.

The term “operation candidate” refers to a suggested action or sequence of actions, derived from an auxiliary model, that a user may execute within a system, such as navigating to a specific function or initiating a particular workflow.

The term “user interface” refers to a combination of software and hardware elements that enable interaction between a user and a system, including input controls, display layouts, and event-handling logic.

The term “selection operation” refers to an input action performed by a user to choose one of multiple presented items, such as tapping, clicking, or otherwise activating a displayed recommended prompt sentence or operation candidate.

The term “user attribute information” refers to data describing characteristics of a user, such as age group, proficiency level, or preference settings, which can be used to adapt system behavior or user interface configuration.

The term “operation history information” refers to information derived from operation history, including aggregated or processed sequences of past user actions, which is used to adapt or optimize system behavior.

The term “display format” refers to an arrangement and visual style of elements on a user interface, including layout, font size, color scheme, and the presence or absence of particular controls or messages.

The term “input method” refers to a mode or mechanism by which a user provides input to a system, such as voice input, text input, touch input, or gesture input.

The term “customized interface” refers to a user interface whose display format and input method are adapted to specific user attributes or operation history so as to improve usability for that user.

The term “cognitive load” refers to the mental effort required by a user to perform an interaction with a system, including understanding displayed information and executing input operations.

The term “behavioral history data” refers to data describing patterns of user behavior over time, such as sequences of accessed functions, executed commands, or responded recommendations.

The term “transaction history data” refers to data describing past transactions associated with a user, including records of operations such as purchases, orders, approvals, or other business events.

The term “transaction policy” refers to a recommended rule, strategy, or guideline for conducting one or more transactions, derived from analysis of transaction history data and behavioral history data.

The term “operational procedure” refers to an ordered set of actions or steps to be executed within a system or organizational process, which may be proposed or optimized based on data-driven analysis of historical operations.

In one embodiment, a server provides a hardware platform for executing the claimed functions. The server includes at least one processor, a main memory, a non-volatile storage apparatus, a network interface, and an audio interface. The processor is implemented by a general-purpose central processing unit or a graphics processing unit, and is configured to execute program instructions stored in the memory. The storage apparatus stores program modules, training datasets, model parameter files, operation history logs, and configuration data. The network interface enables communication with one or more terminals over a communication network. The audio interface is connected to a microphone and a speaker.

In one embodiment, a terminal provides a user-facing hardware platform. The terminal includes an input device such as a keyboard or a touch-sensitive display, a microphone, a display device, and a network interface. The terminal executes a client application, for example a web application running in a web browser or a native application, that sends user inputs to the server and renders responses received from the server.

In one embodiment, a user interacts with the terminal by providing voice input and text input. The user speaks into the microphone of the terminal, and the terminal transmits an audio stream to the server. Alternatively, the terminal performs preliminary digitization and compression of the audio and transmits digitized audio data to the server. The user also enters text input through the keyboard or touch interface of the terminal. The terminal encapsulates the text input and user identifiers and sends them to the server as structured data through the network interface.

In one embodiment, the server executes a voice recognition algorithm to convert the incoming audio signal into text data. The server uses a speech recognition engine that may be based on a neural network model, such as a recurrent neural network, a convolutional neural network, or a transformer-based acoustic model. The server applies feature extraction to the audio signal, for example computing Mel-frequency cepstral coefficients as numerical feature vectors. The server then performs decoding using an acoustic model and a language model to determine a sequence of characters or tokens corresponding to the spoken utterance. The server normalizes the resulting text data, for example by converting to lowercase and standardizing punctuation. The server combines the text data from voice input and the directly entered text input into a unified prompt sentence. By unifying these different input modalities at the server, the system reduces inconsistency between separately processed inputs and eliminates redundant preprocessing, thereby improving accuracy and decreasing processing latency.

In one embodiment, the server accesses an information storage apparatus that contains operational information and historical inquiry information. The information storage apparatus may be implemented as a relational database, a document store, or a combination thereof. The server uses a data access module to retrieve records that include, for example, past prompt sentences, past response sentences, timestamps, identifiers of the user and the terminal, and associated organizational data. The server loads this data into main memory in the form of structured data records.

In one embodiment, the server performs preprocessing on the retrieved information before training a generative AI model. The server uses a data processing library operating on the processor to perform data cleaning, including removal of records with missing essential fields, correction of malformed timestamps, and elimination of duplicate entries. The server performs normalization by standardizing date and time fields into a uniform representation, scaling numeric fields into a bounded range, and converting all text fields into a standardized encoding such as UTF-8. The server performs tokenization of text fields by applying a tokenization algorithm such as subword segmentation. The tokenization process converts prompt sentences and response sentences into sequences of token identifiers suitable for input to a neural network. The server stores the resulting token sequences and associated labels in memory as tensors or comparable multi-dimensional arrays. Because the server uses a consistent preprocessing pipeline, subsequent training and inference operations use homogeneous data structures, which improves cache utilization and reduces conversion overhead at runtime.

In one embodiment, the server implements the generative AI model as a neural network having a transformer-based architecture. The server defines a model including an input embedding layer that maps token identifiers into dense numeric vectors, multiple self-attention layers with multi-head attention mechanisms, feed-forward layers, and a final output layer that produces a probability distribution over a vocabulary for each output position. The server configures hyperparameters such as the number of layers, the number of attention heads, the dimensionality of the embeddings, and the maximum sequence length. The server initializes model parameters, such as weight matrices and bias vectors, either randomly or from a previously stored checkpoint.

In one embodiment, the server trains the generative AI model by executing a machine learning algorithm such as stochastic gradient descent with a variant optimizer. The server loads batches of tokenized prompt sentences and corresponding target response sentences from the preprocessed datasets. For each batch, the server performs forward propagation through the neural network, computing intermediate activations and a predicted probability distribution over tokens for each output position. The server computes a loss value using an error function such as cross-entropy between the predicted token probabilities and the actual target tokens. The server then performs backpropagation to calculate gradients of the loss with respect to the model parameters. The server updates the model parameters using an optimization rule that includes learning rate parameters, momentum terms, and regularization terms. The server repeats these operations across many batches and epochs, storing intermediate checkpoints in the storage apparatus. By performing training in this manner, the server refines internal weight parameters to minimize the loss and thereby increase accuracy of generated responses.

In one embodiment, the server constructs and stores a trained generative AI model after sufficient training. The server stores the model structure definition and the trained weights as parameter files in the storage apparatus. The server loads the trained model into memory at runtime to perform inference processing on prompt sentences received from the terminals. Because the generative AI model is trained specifically on organizational operational information and historical inquiry information, the model learns patterns that are specialized for the organization's data structures and typical queries, improving response relevance and reducing error rates compared to generic models.

In one embodiment, the server performs inference processing when a prompt sentence is received from a terminal. The server applies the same tokenization rules used during training to the prompt sentence, producing a sequence of token identifiers. The server constructs attention masks and positional encodings as additional input arrays. The server then performs forward propagation through the trained generative AI model without updating the parameters. During decoding, the server uses a strategy such as beam search or top-k sampling to generate a sequence of output tokens, where each next token is selected based on the current probability distribution and decoding constraints. The server decodes the generated token identifiers back into text characters, forming a response sentence.

In one embodiment, the server executes postprocessing on the generated response sentence. The server may trim incomplete trailing segments, enforce content filters by matching forbidden patterns or terms in the response, and adjust formatting to conform to organizational style rules. The server transmits the final response sentence to the terminal. The server also converts the response sentence into audio using a text-to-speech synthesis engine. The text-to-speech engine uses an acoustic model, such as a neural network-based waveform generator, to produce a digital audio signal corresponding to the response text. The server outputs the audio signal to a speaker connected to the terminal or the server.

In one embodiment, the terminal receives the response sentence as text and as an optional audio stream. The terminal displays the text in a conversation view on the display device, using graphical components configured to show prompt sentences and response sentences in temporal order. The terminal outputs the audio through a speaker so that the user can listen to the response. The terminal may allow the user to interrupt or replay audio segments by sending control messages to the server.

In one embodiment, the server records operation history for each interaction. The server stores the prompt sentence, the response sentence, timestamps, selected interface elements, and any user feedback in an operation history database. The server organizes the operation history as sequences indexed by user identifiers. Each sequence represents a time-ordered list of events, where an event includes at least a prompt sentence, a response sentence, and metadata describing the context. This sequence structure enables the server to process operation history as time series data suitable for training a separate auxiliary model.

In one embodiment, the server trains the auxiliary model to predict future operations or future inquiry content. The server implements the auxiliary model as a recurrent neural network, a transformer encoder, or another sequence model. The server encodes each event in an operation history sequence as a numerical feature vector that may include embedded representations of the prompt sentence, categorical indicators of the interface state, and numerical indicators of time intervals. The server applies a machine learning algorithm similar to that used for the generative AI model, defining a loss function that measures the difference between predicted next actions and actual next actions observed in the history. The server uses optimization techniques to update the parameters of the auxiliary model. By training the auxiliary model on operation history, the server learns user-specific and population-wide patterns of behavior.

In one embodiment, the server uses the trained auxiliary model during live interactions. When a new prompt sentence is received or when a user opens a particular screen on the terminal, the server constructs a representation of the recent operation history of that user. The server supplies this representation as input to the auxiliary model. The auxiliary model outputs a probability distribution over potential next operations or potential categories of future inquiry content. The server maps these predictions to specific recommended prompt sentences or operation candidates. For example, if a user frequently asks about report generation after viewing a dashboard, the server generates a recommended prompt sentence such as “Generate a weekly performance summary for the current department.” The server sends these recommended prompt sentences and operation candidates to the terminal for display.

In one embodiment, the terminal displays the recommended prompt sentences and operation candidates as selectable items below the input area. The user can tap or click one of the recommendations instead of manually entering a new prompt sentence. When the user selects a recommendation, the terminal transmits the selected recommended prompt sentence to the server as a new prompt sentence. This interaction pattern reduces the number of characters the user must input and reduces the risk of input errors. From a technical perspective, this also reduces the volume of data transmitted over the network and improves end-to-end response time, because the server can prepare appropriate model inputs based on known patterns.

In one embodiment, the server adapts the user interface configuration based on user attribute information and operation history information. The server maintains configuration profiles that map user attributes, such as age group or experience level, and statistical descriptors of operation history, such as error rates or help-request frequency, to interface parameters. The server adjusts parameters such as font sizes, button sizes, layout density, and available interaction modes. For example, for a user classified as an elderly user with high error rates, the server causes the terminal to present larger controls, simplified menus, and more explicit prompts. This adaptation is performed through messages sent over the network, which instruct the terminal to change specific rendering and input parameters in the client application. By adjusting the interface based on quantitative analysis of operation history, the system minimizes cognitive load and reduces the rate of mis-operations at the device level, which constitutes a concrete improvement in the interaction between user and machine.

In one embodiment, the server also incorporates behavioral history data and transaction history data into the training of the generative AI model. The server augments the training dataset by appending transaction-related attributes, such as amounts, categories, and status codes, to the textual context around prompt sentences and response sentences. The server defines feature encodings for these attributes, such as embedding vectors for categorical fields and normalized numeric scalars for quantitative fields. The server feeds these additional feature vectors as auxiliary inputs to specific layers of the generative AI model. In this way, the model internally conditions its token generation not only on textual content but also on structured transactional context. As a result, when the model generates a response sentence or a recommended transaction policy, it can produce contextually appropriate outputs that reflect learned patterns in the transactional data. This joint modeling improves prediction accuracy without requiring multiple independent systems.

In one embodiment, the server manages memory and data structures to increase computational efficiency. The server stores tokenized sequences, embeddings, and intermediate activations in contiguous memory regions, reducing cache misses and memory fragmentation. The server batches multiple prompt sentences received from different terminals and processes them in parallel using vectorized operations on the processor. The server uses quantization or mixed-precision arithmetic for model parameters and activations to reduce memory bandwidth and improve throughput while maintaining acceptable numerical precision. These measures reduce processing time per request and enable the server to support a higher number of concurrent users.

In one embodiment, the server uses model pruning or parameter sharing techniques to reduce the size of the generative AI model and the auxiliary model. The server analyzes the magnitude of weight parameters and removes or shares parameters that contribute minimally to performance. By doing so, the server decreases the number of arithmetic operations required per inference, thereby shortening latency and reducing energy consumption at the hardware level. These technical measures illustrate that the system is not merely automating an existing human workflow, but is redesigning the internal operation of a computing device to achieve better performance.

In one embodiment, the server implements non-conventional rules in the decoding and recommendation pipeline. For example, the server may enforce a rule that the auxiliary model's predicted operation candidates are used to constrain the search space of the generative AI model during decoding, by disallowing tokens that would lead to responses unrelated to the predicted operation. This conditional decoding rule is implemented in the server's decoding algorithm by masking token probabilities that fall outside an operation-specific vocabulary subset. Such a coupling of the auxiliary prediction with the generative decoding process is not typically applied in human workflows and constitutes an improvement in how the machine manages its own search space, leading to lower error rates and more stable outputs.

In one embodiment, the server handles specific prompt sentences such as: “Please explain how to use the new project management software to create a sprint backlog, and provide step-by-step instructions tailored to our company's workflow.” In this case, the server retrieves internal configuration data describing the company's project management settings, uses this data as additional context to the generative AI model, and generates a response sentence that includes concrete steps and interface-specific details. In another example, the user enters: “Generate a weekly performance summary for the sales team, using our internal metrics, and format it as bullet points I can paste into an email.” The server queries internal performance records, aggregates metrics, encodes these metrics as structured features, and feeds them to the generative AI model to generate a summary that reflects the actual data. In a further example, the user enters: “Based on my past tasks, suggest the next three actions I should take to prepare for next week's client meetings.” The server combines the user's historical tasks with auxiliary model predictions to generate a ranked list of recommended actions, thereby providing guidance in a form that the user can directly act upon. In still another example, the user enters: “Draft an internal announcement about the rollout of the new project management tool, including a brief overview, benefits, and a call to action for employees to attend the training session.” The server retrieves organizational policy and style information, uses it as conditioning context, and generates a response sentence that is consistent with internal guidelines.

In alternative embodiments, the server may employ different types of neural network architectures for the generative AI model and the auxiliary model, such as encoder-decoder architectures, hybrid recurrent-attention networks, or sparse attention mechanisms. The server may vary the training regimen by using alternative loss functions, such as label smoothing or sequence-level objectives, and may employ data augmentation techniques such as paraphrasing or synthetic query generation to expand the training set. The server may deploy the models on distributed computing clusters, leveraging multiple processors and specialized accelerators through a communication fabric. Regardless of the specific implementation details, the server continues to perform the essential functions of unifying multi-modal inputs into prompt sentences, training and executing a generative AI model and an auxiliary model using organizational data and operation history, and adapting the user interface and system behavior based on technical analysis of such data, in order to achieve measurable improvements in processing speed, accuracy, resource utilization, and overall reliability of computer-based user support.

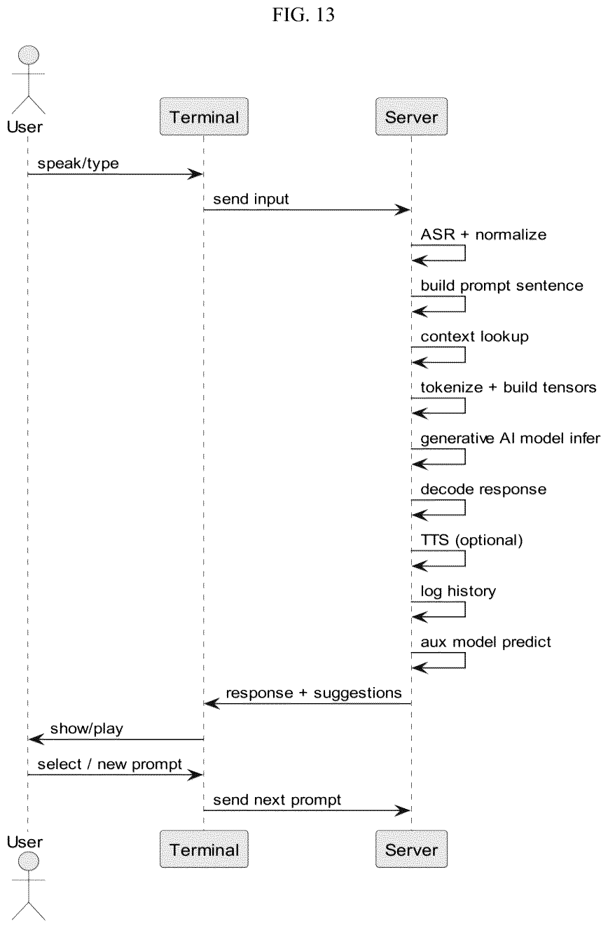

The following describes the processing flow using FIG. 13.

### Step 1:

User provides input through the terminal.

User speaks a request into a microphone of the terminal and/or types a request into a text input field displayed on the terminal.

Input: Analog voice signal and/or raw text characters.

Output: Digitized audio data and raw text data held in the terminal's memory.

Terminal converts the analog voice signal into a digital audio stream using an audio codec, buffers the stream, and associates it with metadata such as a user identifier and a timestamp. Terminal stores the typed text as a character string and prepares both the audio data and text data for transmission.

### Step 2:

Terminal sends user input to the server.

Terminal encapsulates the digitized audio data and the raw text data, together with user identifiers and session identifiers, into a structured request.

Input: Digitized audio data, raw text data, user ID, session ID.

Output: Network request message transmitted to the server.

Terminal packages the data into a protocol message, for example an HTTP request, and uses the network interface to transmit the message over a communication network to the server. Terminal may compress the audio stream and text payload to reduce bandwidth usage.

### Step 3:

Server performs voice recognition and text normalization.

Server receives the network request and extracts the audio data and text data from the message.

Input: Network request containing digitized audio data and raw text data.

Output: Normalized text data representing the spoken content and unified text data for further processing.

Server applies a voice recognition algorithm to the audio data, performing feature extraction, acoustic modeling, and decoding to generate a first text string representing the spoken utterance. Server then normalizes both the first text string and the raw text data by converting them to a standard character encoding, removing extraneous whitespace, and standardizing punctuation. Server concatenates or otherwise combines the normalized text strings into a single unified prompt sentence.

### Step 4:

Server enriches the prompt sentence with context information.

Server analyzes the unified prompt sentence to extract keywords or intent indicators and queries internal data sources for related context.

Input: Unified prompt sentence, organizational data indexes.

Output: Context data records associated with the prompt sentence.

Server uses the prompt sentence as a query against an internal information storage apparatus, such as a database or document index, and retrieves related records including past similar prompt sentences, prior responses, and relevant operational information. Server may rank the retrieved records based on similarity scores and select a subset of context data for use in subsequent processing.

### Step 5:

Server preprocesses the prompt sentence and context data for the generative AI model.

Server converts the prompt sentence and associated context into token sequences and numerical tensors.

Input: Prompt sentence text, context data text and attributes.

Output: Token IDs, attention masks, and auxiliary feature tensors.

Server applies a tokenization algorithm to split the text into tokens and map each token to a numerical identifier. Server constructs attention masks to indicate valid token positions and computes positional encodings. Server also encodes structured attributes from the context data into numerical feature vectors, for example by applying embedding lookups for categorical fields and normalization for numerical fields.

### Step 6:

Server executes inference using the trained generative AI model.

Server feeds the tokenized prompt sentence and auxiliary feature tensors into the trained generative AI model.

Input: Token IDs, attention masks, auxiliary feature tensors, model parameters.

Output: Sequences of token probability distributions and selected output token IDs.

Server performs forward propagation through the neural network layers of the generative AI model, computing intermediate activations and probability distributions over the vocabulary for each output position. Server then applies a decoding algorithm, such as beam search or sampling with constraints, to select a sequence of output token IDs that form a candidate response.

### Step 7:

Server generates and postprocesses the response sentence.

Server converts the selected output token IDs into human-readable text and applies formatting and filtering rules.

Input: Output token IDs, decoding metadata, organizational style rules.

Output: Final response sentence text.

Server decodes the token IDs to a text string using the reverse mapping of the tokenizer. Server then applies postprocessing operations such as trimming incomplete fragments, inserting line breaks where appropriate, and removing or replacing disallowed terms according to predefined rule sets. Server marks the finalized text as the response sentence.

### Step 8:

Server synthesizes audio for the response sentence.

Server converts the response sentence text into an audio signal suitable for playback.

Input: Response sentence text.

Output: Digital audio data representing synthesized speech.

Server inputs the response sentence into a text-to-speech synthesis engine, which encodes the text as phoneme sequences or acoustic features and then generates a waveform or other audio representation. Server may adjust prosody parameters such as pitch and speed to match user or system settings.

### Step 9:

Server logs the interaction as operation history.

Server records details of the prompt sentence, response sentence, and system state at the time of the interaction.

Input: Prompt sentence, response sentence, timestamps, user ID, context identifiers.

Output: Operation history record stored in an operation history database.

Server constructs an event record including the unified prompt sentence, the final response sentence, processing times, model version identifiers, and interface state descriptors. Server appends this event record to a sequence associated with the user and writes the updated sequence to persistent storage.

### Step 10:

Server trains or updates the auxiliary model using operation history.

Server periodically retrieves stored operation history sequences and uses them as training data for the auxiliary model.

Input: Operation history sequences, existing auxiliary model parameters.

Output: Updated auxiliary model parameters and prediction behavior.

Server encodes each event in the history sequence into a feature vector and feeds sequences of feature vectors into the auxiliary model. Server computes a loss function that measures the discrepancy between predicted next operations and actual next operations, and performs backpropagation and parameter updates using an optimization algorithm. Server saves updated auxiliary model parameters to storage for later use in live predictions.

### Step 11:

Server generates recommended prompt sentences and operation candidates.

Server applies the trained auxiliary model during a live session to predict future user actions.

Input: Recent operation history of the user, current prompt sentence or interface state.

Output: Ranked list of recommended prompt sentences and operation candidates.

Server converts the most recent events into feature vectors and feeds them to the auxiliary model, which outputs scores or probabilities for candidate next actions or inquiry types. Server maps these outputs to concrete natural language recommended prompt sentences and specific operation candidates, and orders them according to the predicted likelihood or utility.

### Step 12:

Server sends the response and recommendations to the terminal.

Server prepares a composite message including the response sentence, optional synthesized audio, and recommendations.

Input: Response sentence text, audio data, recommended prompt sentences, operation candidates.

Output: Network response message transmitted to the terminal.

Server embeds the different data elements into a response structure and transmits the structure through the network interface to the terminal. Server may compress the audio data and recommendations to reduce communication load.

### Step 13:

Terminal displays the response and recommendations.

Terminal receives the server's message and updates the user interface.

Input: Network response message containing response sentence text, audio data, and recommendations.

Output: Rendered response text, played audio, and displayed selectable recommendations on the terminal.

Terminal parses the message, renders the response sentence in a conversation area on the display, and starts playback of the audio through the speaker if enabled. Terminal displays recommended prompt sentences and operation candidates as selectable interface elements, such as buttons or list items, in a designated region of the user interface.

### Step 14:

User selects a recommendation or enters a follow-up prompt sentence.

User reviews the response and the displayed recommendations and decides how to proceed.

Input: Displayed response text, played audio, displayed recommendations.

Output: New user input in the form of a selected recommendation or a newly entered prompt sentence.

User may tap or click one of the recommended prompt sentences or operation candidates, causing the terminal to treat the selected text as a new prompt sentence. Alternatively, user may type or dictate a follow-up prompt sentence, such as “Refine this answer into a checklist format” or “Add more detail about the approval workflow,” which the terminal then sends to the server, returning the processing flow to the earlier steps.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional human-computer interaction systems suffer from several technical limitations when processing user inputs and providing assistance. First, speech recognition, natural language understanding, user interface rendering, and transaction processing are typically implemented as isolated modules that do not share a unified representation of user state. As a result, system behavior is statically configured and does not adapt based on a combination of user intent, historical operation patterns, transaction patterns, and inferred emotional state. This leads to inefficient use of computational resources, sub-optimal timing of support actions, and increased interaction steps required from the user.

Second, existing systems that employ machine learning for prediction or use generative models to produce responses generally treat those models as independent components. They do not integrate (i) sequential operation histories, (ii) payment and transaction histories, and (iii) real-time emotion estimation into a coordinated prediction pipeline. Consequently, prediction modules for next operations or payments are trained and executed without feedback from actual user reactions or emotional responses, which limits prediction accuracy and prevents the system from converging towards behavior that reduces user cognitive load and stress.

Third, prompt sentences used to drive generative AI models are usually hand-crafted and static, or, at best, based solely on the current user query. Known systems do not automatically construct prompt sentences that incorporate a rich combination of intent information, state information (such as device context and execution history), learned prediction models, external information resources, and emotion information. This technical shortcoming results in generative responses that are generic, redundant, or misaligned with the user's actual context, thereby increasing the number of system-user turns and processing cycles required to complete a task.

Fourth, user interfaces, including visual and auditory output, are generally configured through fixed templates that are not dynamically optimized by the system on the basis of learned behavioral patterns and emotion signals. For example, existing systems may provide a “large font” mode for elderly users, but they do not algorithmically adapt the structure of operation procedures, the voice guidance speed, and the level of detail in direct response to detected confusion or stress. This lack of dynamic adaptation at runtime leads to failures in guidance, increased error rates, and unnecessary repetition of instructions, which are concrete degradations in the technical performance of the interaction system.

Fifth, payment assistance in existing electronic transaction systems is implemented as a separate business logic layer that does not leverage a predictive model of the user's payment timing and preferred methods combined with real-time emotional state. As a result, recommendation of payment methods is computed without considering whether a particular option is likely to reduce user stress or interaction complexity at that moment. This separation of payment prediction, emotion recognition, and generative explanation logic leads to fragmented data processing pipelines, reduced prediction accuracy, and increased processing overhead due to repeated, context-agnostic recommendation computation.

Accordingly, there is a need for a technical architecture and processing method that (i) unifies acquisition of voice, text, operation, transaction, and biometric inputs; (ii) maintains and learns from operation histories and transaction histories using machine learning models; (iii) estimates emotion from multimodal data; (iv) automatically generates context-rich prompt sentences for a generative AI model based on these learned and inferred states; (v) generates response information and support information that can be used to automatically or semi-automatically control application activation, function execution, and payment processing; and (vi) closes the loop by feeding back user reactions and emotions to update prediction models and prompt generation logic. By implementing such a system, it becomes possible to technically improve the efficiency, accuracy, and adaptability of the computer's interaction and assistance functions, thereby reducing computational waste, lowering user interaction steps, and improving the robustness of the overall information processing system.

The specific processing by the specific processing unit 290 of the data processing device 12 in Application Example 2 is realized by the following means.

The present invention provides a server comprising a processor configured to acquire input information from a terminal device operated by a user, the input information including at least one of voice information, text information, operation information, transaction information and biometric information; to convert the voice information into character information using a speech recognition algorithm; to record the operation information as an operation history together with time-series information and store the operation history in a storage; to analyze at least the character information and the operation history using a natural language processing technique and a statistical processing technique to extract intention information and state information of the user; to estimate emotion information of the user on the basis of at least one of the character information, the voice information and facial expression information included in the biometric information; to train an action prediction model and a payment prediction model using a machine learning algorithm on the basis of the operation history and a transaction history; to generate, on the basis of at least one of the intention information, the state information, the emotion information, the action prediction model, the payment prediction model and external information resources, a prompt sentence to be input to a generative AI model; to cause the generative AI model to operate using the prompt sentence to generate response information including at least one of procedure information, operation guidance information, payment recommendation information and inquiry response information; to generate support information for automatically or semi-automatically assisting at least one of application activation, function execution and payment processing in the terminal device on the basis of the response information, the action prediction model and the payment prediction model; to present the response information and the support information to the user using a display device for visual presentation and a voice synthesis technique for auditory presentation; and to acquire feedback information including at least one of operation information and emotion information of the user in response to the presentation and update at least one of the action prediction model, the payment prediction model and processing for generating the prompt sentence on the basis of the feedback information. This enables an integrated, feedback-driven computation pipeline in which the server continuously refines prediction models and prompt generation logic using real user behavior and emotional responses, improves the contextual relevance and precision of outputs generated by the generative AI model, reduces the number of interaction steps and failed guidance attempts, and dynamically adapts user interface behavior and support actions so as to enhance the technical performance, efficiency and robustness of the computer-implemented interaction and transaction assistance system.

The term “processor” refers to a hardware or virtual computation unit, such as a central processing unit or processing circuitry, configured to execute instructions of a program to perform information processing, analysis, model training, and control of input and output functions.

The term “terminal device” refers to an information processing apparatus operated by a user, such as a handheld device, a wearable device, or a personal computer, that is configured to capture user inputs and present outputs.

The term “input information” refers to data acquired from the terminal device or from associated systems, including at least one of voice information, text information, operation information, transaction information, and biometric information.

The term “voice information” refers to audio data representing speech uttered by a user and captured by a sound input component such as a microphone.

The term “text information” refers to character-based data input by the user or generated by the system, including natural language sentences, commands, and symbols.

The term “operation information” refers to event data indicating user interactions with the terminal device or applications, including at least one of application activation, application termination, screen transition, control selection, and input focus changes.

The term “transaction information” refers to data representing electronic transactions conducted by the user, including at least one of transaction time, transaction amount, transaction counterpart, and payment method.

The term “biometric information” refers to data representing physical or behavioral characteristics of the user, including at least one of facial image data, body movement data, speech characteristics, and physiological signals.

The term “speech recognition algorithm” refers to a computation method that converts voice information into character information by analyzing acoustic features of the speech signal.

The term “character information” refers to symbolic data obtained by converting voice information into text using the speech recognition algorithm, or received directly as text information.

The term “operation history” refers to a sequence of operation information records stored together with associated time-series information, representing past interaction behavior of the user with the terminal device or applications.

The term “time-series information” refers to data indicating temporal attributes of events, including at least one of timestamps, time intervals, and chronological ordering information.

The term “storage” refers to a hardware or logical data retention component, such as a memory or database, configured to store operation history, transaction history, models, and other information.

The term “natural language processing technique” refers to a computation technique for analyzing character information expressed in natural language, including at least one of tokenization, syntactic analysis, semantic analysis, and entity extraction.

The term “statistical processing technique” refers to a computation method that analyzes data using statistics, including at least one of frequency analysis, distribution analysis, correlation analysis, and clustering.

The term “intention information” refers to information indicating the purpose or requested action of the user, derived by analyzing character information and other context using the natural language processing technique and statistical processing technique.

The term “state information” refers to information indicating a current or recent contextual condition related to the user or the terminal device, including at least one of device status, application status, interaction history summary, and environmental conditions.

The term “emotion information” refers to information indicating an estimated emotional state of the user, such as satisfaction, confusion, stress, or anger, inferred from at least one of character information, voice information, and biometric information.

The term “facial expression information” refers to image-based biometric information representing one or more facial regions of the user and used to infer the user's emotional state.

The term “machine learning algorithm” refers to a computation method that adjusts parameters of a model using training data so that the model can perform prediction, classification, or generation based on patterns in the data.

The term “action prediction model” refers to a model obtained by training with a machine learning algorithm on the basis of the operation history, and configured to output a prediction of at least one of a next operation, a timing of the next operation, and a probability distribution over candidate operations.

The term “payment prediction model” refers to a model obtained by training with a machine learning algorithm on the basis of the transaction history, and configured to output a prediction of at least one of a next payment timing, a next payment amount, and a likely payment method.

The term “transaction history” refers to a collection of transaction information records stored with associated time-series information, representing past electronic transactions conducted by the user.

The term “external information resources” refers to data sources accessible via a communication network outside the server's primary storage, including at least one of external databases, document repositories, and network-based information services.

The term “prompt sentence” refers to a text string constructed to be input to a generative AI model, the text string including instructions, context, and data elements that condition the output of the generative AI model.

The term “generative AI model” refers to a trained computation model configured to generate output data, such as natural language text, in response to input data including a prompt sentence.

The term “response information” refers to information generated by the generative AI model based on the prompt sentence, including at least one of procedure information, operation guidance information, payment recommendation information, and inquiry response information.

The term “procedure information” refers to response information that describes a sequence of steps or operations to achieve a given objective in a system, device, workflow, or process.

The term “operation guidance information” refers to response information that indicates how the user should perform one or more operations on the terminal device or applications, including explanations, hints, or recommended actions.

The term “payment recommendation information” refers to response information that indicates one or more recommended payment methods, payment timings, or payment configurations for a forthcoming or current transaction.

The term “inquiry response information” refers to response information that provides an answer, explanation, or advice in response to a user inquiry expressed in natural language.

The term “support information” refers to information for controlling or influencing behavior of the terminal device or applications so as to automatically or semi-automatically assist at least one of application activation, function execution, and payment processing.

The term “application activation” refers to a process of starting or bringing to foreground an executable software component on the terminal device in response to a system decision or user input.

The term “function execution” refers to a process in which a specific operation or feature of software on the terminal device is invoked and carried out according to internal logic of the software.

The term “payment processing” refers to a sequence of operations that perform an electronic transaction for transferring value from the user to a counterparty, including at least one of authorization, settlement, and confirmation.

The term “display device” refers to a hardware component configured to visually present information to the user, such as a screen, head-mounted display, or projection device.

The term “voice synthesis technique” refers to a computation method that converts character information into audio signals representing speech, for playback to the user.

The term “feedback information” refers to information obtained after presentation of response information and support information, including at least one of subsequent operation information and emotion information of the user.

The term “user interface” refers to a configuration of visual, auditory, and interactive elements used to present information to the user and receive inputs from the user.

The term “attribute information” refers to information representing characteristics of the user, including at least one of age category, usage proficiency, and preference settings.

The term “optimal payment method” refers to a payment method, determined based on at least the payment prediction model, the emotion information, and the transaction history, that is evaluated to be favorable with respect to at least one of user burden, timing, cost, and risk.

The term “payment means” refers to a category or type of instrument used to execute a payment, including at least one of a credit-based instrument, a debit-based instrument, an account transfer, and a stored-value instrument.

The term “installment condition” refers to a parameter or set of parameters specifying how a payment is divided into multiple portions, including at least one of number of installments, interval between installments, and interest or fee conditions.

The term “payment timing” refers to a point in time or schedule according to which a payment or a portion of a payment is executed or becomes due.

In one or more embodiments, a server cooperates with one or more terminals to implement the claimed system. The server includes a processor, a memory, a non-transitory storage device, and a network interface. The terminal includes at least one processor, a memory, a display device, an audio input device such as a microphone, an audio output device such as a speaker, and optionally an image capture device such as a camera. The server and the terminal are connected via a communication network, for example a packet-switched network.

Server stores executable programs in the memory or storage device. The executable programs define modules including an input acquisition module, a speech recognition interface module, a natural language processing module, a logging and history management module, a machine learning training module, an emotion estimation module, a prompt generation module, a generative AI interface module, a support information generation module, a feedback processing module, and a user interface adaptation module. Terminal stores a client application that cooperates with these modules to acquire user inputs and present outputs.

Server uses hardware resources such as a multi-core central processing unit and, in some embodiments, a graphics processing unit or specialized accelerator to execute numerical computations for neural network training and inference. Server uses software libraries and frameworks such as a generic deep learning framework (for example, a framework capable of defining multi-layer neural networks and backpropagation), a natural language processing library (for example, a library capable of tokenization, part-of-speech tagging, dependency parsing and named entity recognition), and a speech recognition service (for example, a network-accessible speech-to-text service). Server uses a database management system to store operation histories, transaction histories, model parameters, and logs. Terminal uses an operating system API to access the microphone, camera, and display.

User operates the terminal to provide input information. User provides voice information by speaking into the microphone, text information by typing or selecting items on the display, and operation information by activating or terminating applications, pressing buttons, or navigating screens. User optionally performs electronic payments through an application on the terminal; corresponding transaction information is recorded and transmitted to the server. User's biometric information, such as facial image data and speech characteristics, is captured by the terminal's camera and microphone during interaction.

Terminal formats the input information before sending it to the server. Terminal encapsulates voice information as compressed audio frames including timestamp metadata. Terminal encapsulates text information and operation information as structured records, for example records including a user identifier, an application identifier, an event type, and a timestamp. Terminal encapsulates biometric information such as facial images as image frames or as extracted feature vectors computed by a local feature extractor. Terminal transmits these records to the server via a network protocol such as HTTPS.

Server stores operation information as an operation history in the database. Server assigns each operation record a time-series index, such as a monotonically increasing timestamp and, optionally, a session identifier. Server organizes the operation history as sequences of events per user and per application. Server also stores transaction information as a transaction history, including fields such as transaction time, transaction amount, category, and payment method. These histories are stored in a normalized table structure or in a sequence-oriented data structure optimized for sequential access.

Server converts voice information into character information using a speech recognition algorithm. In one embodiment, server sends audio frames to an external or internal speech recognition engine that implements a neural network based acoustic model and a language model. The acoustic model may be a deep neural network such as a time-delay neural network, a recurrent neural network, or a transformer model configured to map acoustic features to phonetic units. The language model may be an n-gram model or a neural language model. The speech recognition engine computes a sequence of feature vectors from the raw audio, computes likelihoods of phonetic units, and determines the most probable sequence of words by combining acoustic and language model scores. Server receives the recognized text, which becomes the character information associated with the original voice input.

Server analyzes character information and operation history using a natural language processing technique and a statistical processing technique. Server uses a natural language processing library to segment the character information into tokens, annotate part-of-speech tags, and compute a syntactic dependency tree. Server extracts intent information by matching intent patterns or by using a classification model trained on labeled intent data. Server extracts entities such as device names, operation types, product categories, or payment methods. Server combines this linguistic analysis with statistical processing of the operation history, for example computing frequencies of certain command patterns, co-occurrence of intents with particular applications, and temporal patterns of operations.

Server estimates emotion information of the user based on multiple modalities. Server uses text-based emotion estimation by applying a sentiment analysis or tone analysis model to character information. Server uses voice-based emotion estimation by computing acoustic features such as pitch, intensity, and speaking rate from voice information and feeding them into a classifier, such as a neural network that maps these features to emotion labels such as “calm,” “confused,” “stressed,” or “angry.” Server uses facial expression information by applying an image analysis algorithm, such as a convolutional neural network, to facial image data to produce emotion probabilities. Server fuses the text-based, voice-based, and face-based estimates, for example by weighted averaging or by inputting the individual emotion probability vectors into a fusion network, to produce a single emotion information representation.

Server trains an action prediction model based on the operation history. In one embodiment, server represents each operation event as a categorical vector including features such as application identifier, screen type, action type, and time-of-day bucket. Server maps these features to embedding vectors and constructs sequences of embeddings per user. Server uses a sequence model such as a recurrent neural network, a gated recurrent unit network, or a transformer network. The sequence model receives the sequence of past operations and outputs a probability distribution over possible next operations. Server trains the model using supervised learning where the target is the actual next operation observed in the history.

Server uses a loss function such as cross-entropy loss between the predicted distribution and a one-hot encoding of the actual next operation, and updates the model parameters using gradient descent or a variant such as Adam. Server periodically retrains or fine-tunes the model as new operation history data are accumulated.

Server trains a payment prediction model based on the transaction history. Server encodes each transaction as a feature vector including the transaction amount, day-of-month, day-of-week, merchant category, and payment method. Server optionally includes user-specific features, such as a vector representing the user's historical average payment amount and variability. Server uses a recurrent neural network or other sequence model to predict the timing and method of the next payment. Alternatively, server uses a mixture density network that outputs parameters of a probability distribution over the next payment time and amount. Server trains this model using a loss function appropriate for time-to-event prediction, such as negative log-likelihood under the predicted distribution. The resulting payment prediction model outputs, for example, an expected next payment date and a probability distribution over payment methods.

Server stores the parameters of the action prediction model and the payment prediction model in a model repository. Server uses versioning so that different generations of models can be identified and rolled back if needed. Server records metadata such as training dataset identifiers, training time, hyperparameters, and validation accuracy. This explicit tracking of model versions and associated training conditions improves reproducibility and allows technical evaluation of improvements.

Server generates a prompt sentence to be input to a generative AI model based on the extracted and learned information. Server first selects relevant context data: intent information, state information such as device context, emotion information, summaries of the operation history and transaction history, and outputs of the action prediction model and payment prediction model. Server then concatenates this information into a structured natural language input. In one embodiment, server uses templates describing roles and tasks for the generative AI model. For example, server generates a prompt sentence such as:

“You are a support AI for factory operators. Use the following manual to answer the user's question in clear numbered steps. Manual: [manual text for the relevant machine]. Question: ‘Please tell me the maintenance procedure for this machine.’ Answer in short, easy-to-follow steps.”

In another embodiment, server generates a prompt sentence for payment recommendation such as:

“You are a payment assistant AI. The user's payment history is: [summary of recent transactions]. The predicted next bill is on [predicted date], and the user's current emotion is ‘stressed’. Generate two or three payment options that reduce stress, such as installments or deferred payment, and explain them briefly.”

Server may also generate a prompt sentence for operation prediction and automatic assistance, such as:

“Learn that the user opens a news application every morning at 7:00 and describe the logic to automatically open that application when the smartphone starts next time.”

Server thus uses specific, structured prompt sentences that embed not only the current query, but also learned prediction results and emotion information. This non-conventional prompt construction allows the generative AI model to generate responses that are aligned with both the user's intent and the predicted future context, thereby reducing unnecessary follow-up queries and computational cycles.

Server communicates with a generative AI model using the prompt sentence. In one embodiment, server hosts the generative AI model locally, for example a transformer-based language model comprising multiple attention layers, feed-forward layers, and learned embeddings. The model accepts a sequence of tokens representing the prompt sentence and generates a sequence of output tokens by iterative decoding, at each step computing attention over previous tokens and applying learned weight matrices. In another embodiment, server accesses the generative AI model as a remote service via an application programming interface. Server transmits the prompt sentence as input; the generative AI model returns response information as generated text.

Server post-processes the generated response information. Server identifies structural patterns, such as numbered lists, bullet lists, and section headings, and ensures that the response satisfies desired constraints, for example a maximum length or minimal number of steps. Server may add annotations linking parts of the response to relevant reference documents. Server converts the generated response into a structured internal representation including at least one of procedure information, operation guidance information, payment recommendation information, and inquiry response information.

Server generates support information for automatically or semi-automatically assisting operations on the terminal. For example, when the action prediction model outputs a high probability that the user will open a particular application at a particular time, server generates a support record instructing the terminal either to open the application automatically or to present a suggestion notification. When the payment prediction model forecasts an upcoming payment, server generates support information indicating a recommended payment method and a recommended timing. Server encodes this support information as commands or recommendations with associated conditions.

Terminal receives the response information and support information from the server. Terminal renders the response information on the display, using a user interface configuration provided by the server or derived from local settings. When the server indicates that the user is an elderly person and is confused, terminal enlarges fonts, slows down scroll speeds, and uses simpler layouts. Terminal also synthesizes audio from the response information using a voice synthesis technique; for example, terminal sends the text to a text-to-speech engine which converts the text into audio waveforms by performing linguistic analysis, prosody generation, and waveform generation. Terminal plays the synthesized audio through the speaker.

Terminal executes automatic or semi-automatic actions based on the support information. When support information indicates automatic application activation, terminal checks the current device state and, if allowed, activates the specified application using an application management interface. When support information indicates function execution, such as opening a specific settings screen, terminal invokes the corresponding function through operating system calls. When support information indicates a recommended payment option, terminal presents selectable buttons and, upon user selection, invokes a payment processing module that interacts with external payment infrastructure.

Server acquires feedback information based on the user's reaction to the presented response information and support information. Terminal records whether the user follows suggested actions, ignores them, or cancels them. Terminal records changes in emotion information, such as reduction or increase in stress, estimated by analyzing speech and facial expressions after the guidance. Terminal transmits this feedback information to the server. Server stores the feedback in association with the corresponding prediction and prompt that produced the guidance.

Server updates the action prediction model, the payment prediction model, and the prompt generation processing based on feedback information. Server uses additional training cycles where prediction errors or unsatisfactory outcomes are emphasized. For example, server assigns higher loss weights to sequences where predictions were rejected or led to negative emotions. This adjusted training systematically moves model parameters away from behaviors that users reject and towards behaviors that users accept, thereby improving prediction accuracy and reducing unnecessary activations. Server also adjusts rules and templates for prompt sentence generation, for example by adding more context for users who frequently express confusion, or by simplifying explanation style for elderly users.

Server and terminal together provide technical improvements over conventional systems. Because server maintains explicit models for predicting user operations and payments and updates these models with real-time feedback, the system reduces the number of times terminal must request explicit user input. This reduces communication overhead and processing latency by decreasing the number of network round trips and by avoiding redundant computations. The use of learned prediction models and multimodal emotion estimation enables the server to select support actions that are more likely to succeed, which decreases the number of failed guidance attempts and repeated interactions, thereby improving processing efficiency and resource utilization.

Server also improves the internal operation of the computer system by structuring data into specific histories and by controlling the flow of information through specialized modules. The operation history is stored as ordered sequences optimized for sequential model training; the transaction history is normalized and indexed for efficient time-series queries. The training module uses specific loss functions and weight updates to align predictions with observed behavior and emotional outcomes, rather than merely automating a fixed human decision process. The prompt generation module encodes learned models and emotion states into textual instructions in a way that is not customary in general-purpose natural language interfaces, thus enabling the generative AI model to operate under a richer machine-interpreted context.

In some embodiments, server uses additional techniques to improve computational performance. For example, server performs batch processing of operation histories to train the models during off-peak hours, uses mini-batch gradient descent to make efficient use of processor caches, and prunes rarely used branches in the prediction space to reduce model size. Server compresses internal representations and discards redundant features to reduce memory consumption. These techniques collectively reduce training and inference time, which improves the responsiveness of the system.

In further embodiments, different variations of the architecture can be employed without departing from the technical concept. Server may host the generative AI model locally or access it through different remote services; the action prediction model may be implemented with different neural network architectures such as convolutional sequence models or attention-only models; the emotion estimation module may use rule-based classifiers for certain modalities as a fallback. Terminal may perform partial preprocessing, such as local feature extraction for facial images, to reduce bandwidth requirements. Server may adjust the weight given to different modalities in the emotion estimation depending on device capabilities, thereby maintaining robustness across heterogeneous terminals.

User in all embodiments interacts with the system through the terminal without needing to be aware of the internal processing. The claimed configuration thus provides a concrete, technical implementation where the server's processor executes specific algorithms, employs defined data structures, and coordinates terminal behavior to improve the speed, accuracy, and efficiency of computer-implemented assistance, rather than merely replacing human decision making with generic computation.

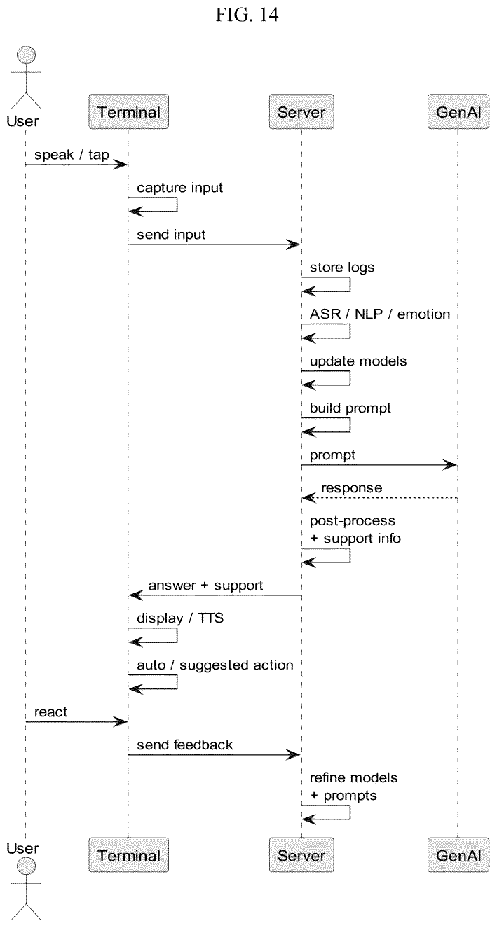

The following describes the processing flow using FIG. 14.

### Step 1:

User provides input to the terminal.

User speaks a query such as “Please tell me the maintenance procedure for this machine,” types a question such as “Please explain the steps to start a new project,” or performs operations such as opening applications, navigating screens, and executing payments.

Input: Human voice, typed text, and interaction actions on the terminal UI.

Output: Raw audio signals at the microphone, character strings in text fields, and event signals in the terminal's event queue.

### Step 2:

Terminal captures and structures the input information.

Terminal samples the microphone signal into digital audio frames, reads typed text from input widgets, and records interaction events with fields such as event type, application identifier, control identifier, and timestamp. Terminal also captures biometric data such as facial images from a camera if available. Terminal converts these raw signals into structured records and attaches metadata such as user identifier, device identifier, and time.

Input: Raw audio samples, raw text input, UI events, and raw image frames.

Output: Structured input records including voice information (audio frames with metadata), text information (strings with metadata), operation information (event logs with timestamps), and biometric information (image or feature vectors).

### Step 3:

Terminal transmits structured input information to the server.

Terminal aggregates the structured records into request messages and sends them to the server via a secure network protocol such as HTTPS. Terminal may batch multiple operation events together to reduce communication overhead.

Input: Structured input records stored in the terminal buffer.

Output: Network messages containing voice information, text information, operation information, transaction information, and biometric information delivered to the server.

### Step 4:

Server stores operation and transaction information as histories.

Server receives the network messages and parses them into internal data objects. Server writes operation information into an operation history table, assigning each record a session identifier and an ordered timestamp. Server writes transaction information into a transaction history table, normalizing fields such as currency and merchant category.

Input: Parsed operation information and transaction information from the terminal.

Output: Operation history and transaction history stored in a database with time-series indexing and normalized schemas.

### Step 5:

Server converts voice information to character information.

Server sends audio frames to a speech recognition engine. The engine computes acoustic features such as Mel-frequency cepstral coefficients, applies a neural acoustic model and a language model, and decodes the most likely word sequence. Server receives the recognized text string and associates it with the original audio record.

Input: Voice information (audio frames with metadata).

Output: Character information (recognized text) mapped to the corresponding user, session, and timestamp.

### Step 6:

Server analyzes character information and extracts intent and entities.

Server uses a natural language processing library to tokenize the character information, assign part-of-speech tags, and build a dependency parse. Server applies an intent classifier to the parsed text to determine a label such as “request maintenance_procedure” or “request_payment_advice.” Server extracts entities such as device identifiers, application names, product categories, or monetary values.

Input: Character information and language model resources.

Output: Intent information (intent label) and entity information (structured list of extracted items) linked to the original input.

### Step 7:

Server analyzes operation history statistically to derive state information.

Server queries the operation history for recent actions of the user, orders them chronologically, and computes summary statistics such as frequency of application usage, typical sequences of operations, and distribution of times of day for each operation. Server represents the current state as a feature vector including most recently used applications, current active application, and recent failure or error events.

Input: Operation history records for the user.

Output: State information summarizing recent behavior and context for the user and terminal.

### Step 8:

Server estimates emotion information from text, voice, and facial expressions.

Server passes character information to a text-based emotion classifier, which computes sentiment scores or emotion probabilities. Server passes audio features such as pitch contours and energy to a voice-based emotion classifier. Server passes facial image features to a facial expression classifier. Server combines these outputs, for example by computing a weighted sum or by feeding them into a fusion network, to determine an overall emotion label such as “confused,” “stressed,” or “calm” and an associated confidence value.

Input: Character information, voice information (or derived audio features), and biometric information (facial features).

Output: Emotion information comprising an emotion label and confidence scores stored as part of the user's current context.

### Step 9:

Server updates and trains an action prediction model using the operation history.

Server selects sequences of past operations from the operation history and encodes each operation into a feature vector including application identifier, action type, and time bucket.

Server feeds these sequences into a neural sequence model (for example, a recurrent network or transformer) and computes a loss by comparing the model's predicted next operation with the actual next operation. Server updates the model parameters using gradient-based optimization.

Input: Operation history sequences and current model parameters.

Output: Updated action prediction model capable of outputting a probability distribution over candidate next operations for a given sequence.

### Step 10:

Server updates and trains a payment prediction model using the transaction history.

Server extracts transaction sequences for each user, constructs feature vectors including transaction amount, day-of-month, day-of-week, category, and payment method, and feeds these sequences into a temporal model. Server defines a loss function that measures the discrepancy between predicted next payment time and method and the actual observed values. Server computes gradients and updates the model weights.

Input: Transaction history sequences and current payment prediction model parameters.

Output: Updated payment prediction model capable of estimating the next payment timing and a distribution over payment methods.

### Step 11:

Server predicts upcoming operations and payments for the current context.

Server feeds the most recent segment of the user's operation history into the action prediction model to compute a probability distribution over next operations. Server feeds the most recent segment of the transaction history into the payment prediction model to compute an expected next payment date and preferred method. Server selects operations and payment events that exceed configured probability thresholds as candidates for assistance.

Input: Recent operation history, recent transaction history, and trained models.

Output: Predicted operations (with probabilities) and predicted payment events (timing and method suggestions) stored as part of the current context.

### Step 12:

Server selects context data for prompt sentence construction.

Server gathers intent information, state information, emotion information, predicted operations, predicted payment events, and any relevant external information resources such as manuals or guidelines. Server formats summaries, for example by compressing histories into human-readable descriptions and by selecting only top-ranked predicted items.

Input: Intent information, state information, emotion information, action prediction output, payment prediction output, and external resources.

Output: Structured context bundle containing all elements needed to construct a prompt sentence.

### Step 13:

Server generates a prompt sentence for a generative AI model.

Server applies a template engine that fills parameterized natural language templates with values from the context bundle. For a maintenance query, server inserts the machine manual text and the user's question into a support template. For a payment recommendation, server inserts a summary of payment history, the predicted next bill date, and the current emotion label into a payment template. For example, server generates a prompt sentence such as: “You are a payment assistant AI. The user's payment history is: [summary]. The predicted next bill is on [date], and the user's current emotion is ‘stressed’. Generate two or three payment options that reduce stress, such as installments or deferred payment, and explain them briefly.”

Input: Structured context bundle and predefined templates.

Output: Prompt sentence text tailored to the specific user situation and task.

### Step 14:

Server sends the prompt sentence to the generative AI model and obtains response information.

Server tokenizes the prompt sentence into input tokens compatible with the generative AI model and transmits them via a local interface or network API. The generative AI model processes the tokens through its stacked attention and feed-forward layers and generates output tokens representing the response. Server detokenizes these output tokens into a text string.

Input: Prompt sentence text and generative AI model parameters.

Output: Generated response text containing at least one of procedure information, operation guidance information, payment recommendation information, and inquiry response information.

### Step 15:

Server post-processes the generated response into structured response information.

Server parses the generated text to identify numbered lists, steps, or option descriptions.

Server extracts explicit instructions, such as “open the front panel,” “tap the settings icon,” or “use installment payment.” Server converts these to a structured format, for example a list of steps with action types, targets, and order.

Input: Generated response text from the generative AI model.

Output: Structured response information with explicit stepwise procedures and recommendation entries.

### Step 16:

Server generates support information for automatic or semi-automatic assistance on the terminal.

Server maps predicted operations and structured response elements to concrete actions on the terminal. If the action prediction model shows high probability that the user will open a specific application at a particular time, server creates a support command instructing the terminal to auto-launch or suggest that application. If the payment prediction model and generated response indicate a recommended payment option, server defines data specifying payment type, default selection, and associated UI elements.

Input: Structured response information, predicted operations, and predicted payment events.

Output: Support information including device-executable commands, suggested actions, and configuration parameters for the terminal UI.

### Step 17:

Server transmits response information and support information to the terminal.

Server constructs a response message containing the human-readable response text, the structured steps, and the support command set. Server sends this message to the terminal over the network.

Input: Structured response information and support information.

Output: Network message containing display content, audio content, and action commands delivered to the terminal.

### Step 18:

Terminal presents response information to the user.

Terminal renders the response text in graphical form on the display, choosing font size, layout, and color scheme based on user attribute and emotion information received from the server. Terminal invokes a text-to-speech engine to convert the response text into audio and plays it through the speaker at a speed adjusted for user characteristics (for example, slower for elderly users).

Input: Response text and UI parameters from the server.

Output: Visual output on the display and auditory output from the speaker observable by the user.

### Step 19:

Terminal executes automatic or semi-automatic support actions.

Terminal interprets support information received from the server. When instructed to auto-launch an application, terminal issues an operating system call to start the specified application. When instructed to present a suggestion, terminal displays a notification such as “Would you like to open your usual news application now?” with selectable buttons. For payment assistance, terminal shows buttons for options such as “Pay in full,” “Pay in installments,” or “Pay later,” with one option highlighted as recommended.

Input: Support information comprising commands and UI configuration.

Output: Executed application launches, function calls, and rendered interactive UI elements enabling streamlined operations.

### Step 20:

User reacts to the presented information and support actions.

User reads the display, listens to the voice guidance, and decides whether to accept automatic suggestions, tap recommended options, or request further assistance. User's actions, such as tapping “Yes” to open an application, selecting a payment option, or cancelling a recommendation, generate new operation events. User's voice and facial expression during this interaction may also change, reflecting satisfaction or frustration.

Input: Visual and auditory outputs and suggested actions from the terminal.

Output: New user actions (taps, swipes, spoken responses) and updated biometric signals.

### Step 21:

Terminal captures user reaction and emotion as feedback information.

Terminal records the new operation events into its event log, annotating them as responses to specific recommendations or guidance. Terminal captures updated voice and facial data while the user interacts, and may compute local emotion features. Terminal sends this feedback, including which recommendations were accepted or rejected and any changes in estimated emotion, back to the server via the network.

Input: User's follow-up actions and biometric signals after guidance.

Output: Feedback information records containing operation information and biometric-based emotion indicators transmitted to the server.

### Step 22:

Server updates models and prompt generation logic based on feedback.

Server associates each piece of feedback with the corresponding predictions and prompt sentences that led to the guidance. Server uses accepted or rejected recommendations as additional labels to retrain the action prediction model and the payment prediction model, for example by increasing the loss weight on mispredicted or rejected actions. Server analyzes patterns of emotion change to adjust how much emphasis to place on certain types of assistance. Server modifies prompt templates, for example simplifying wording for users who frequently express confusion, or including more context for users who often ask follow-up questions.

Input: Feedback information, stored prompt sentences, and previous prediction outputs.

Output: Updated model parameters and refined prompt generation templates that improve future prediction accuracy, response relevance, and interaction efficiency.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

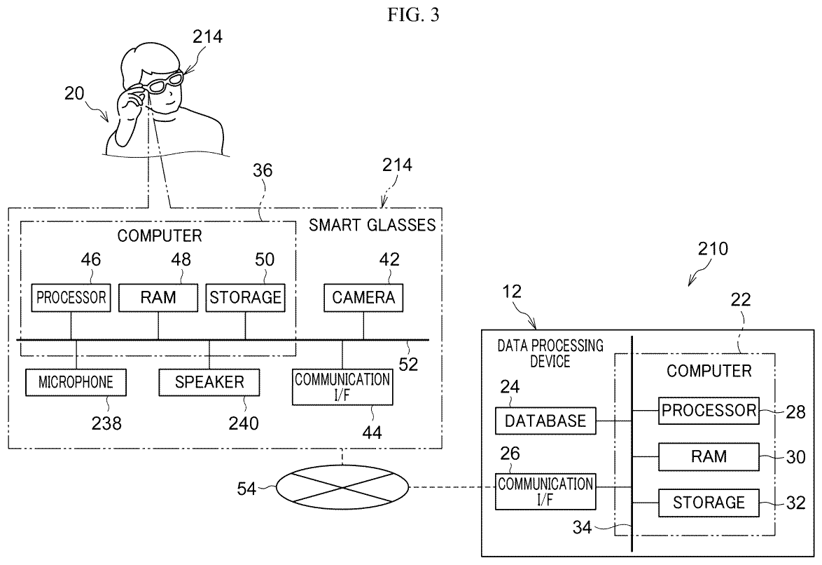

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

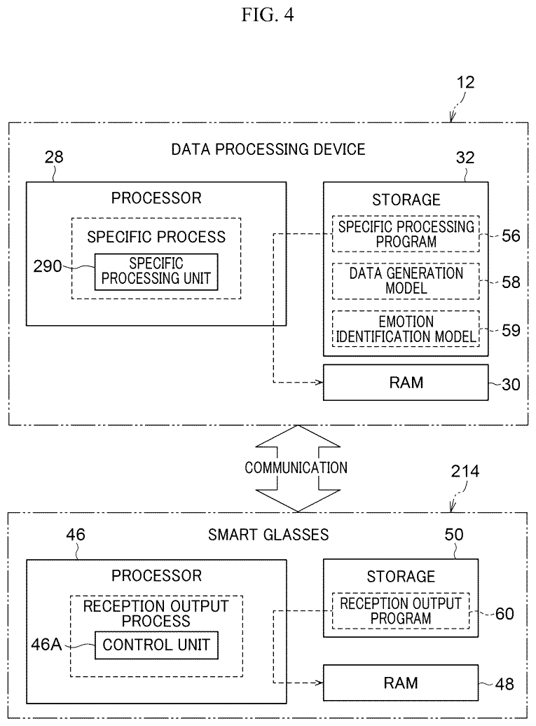

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

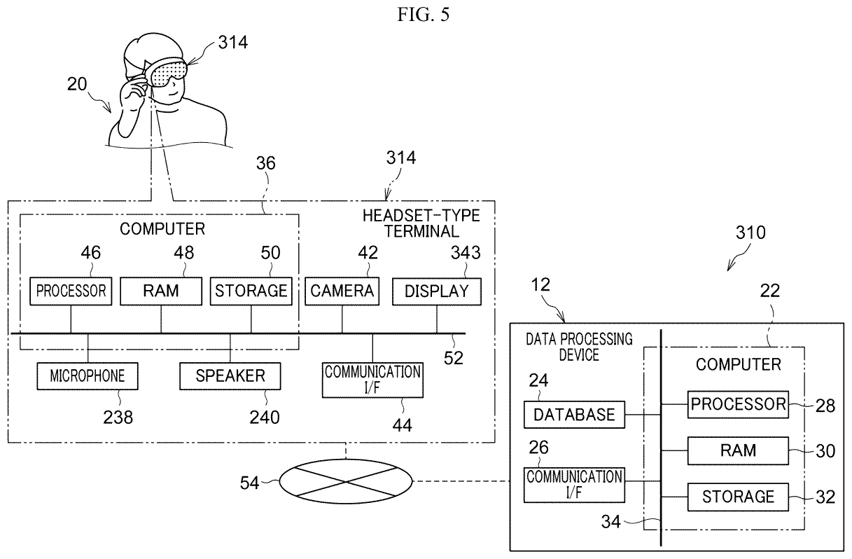

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

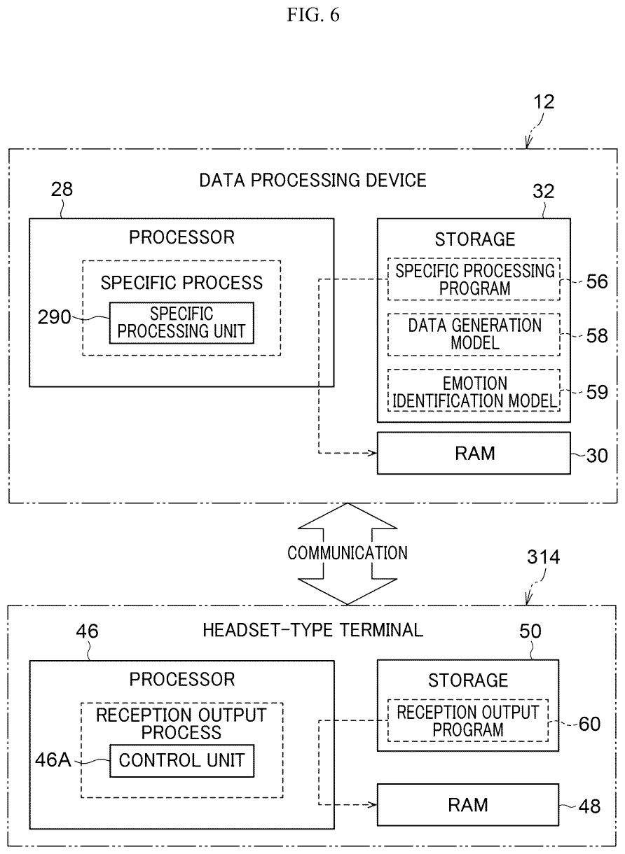

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

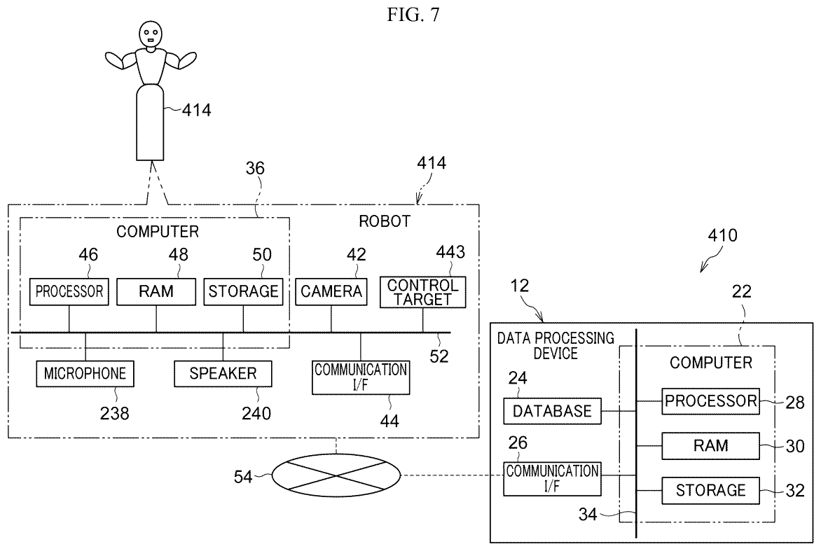

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

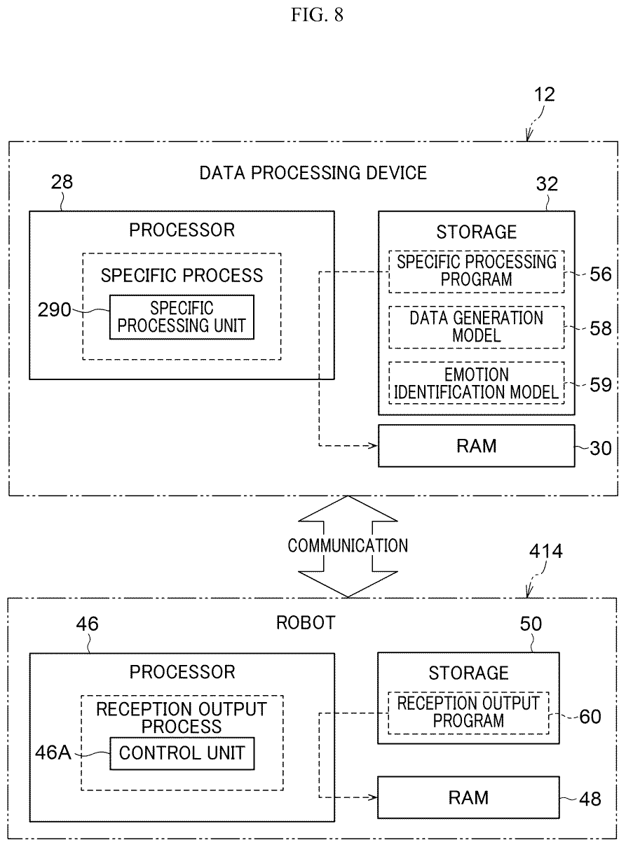

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

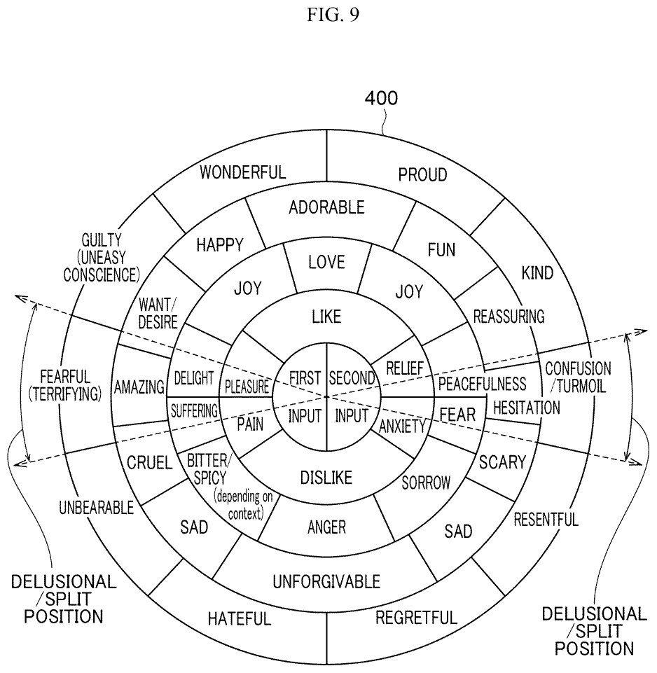

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

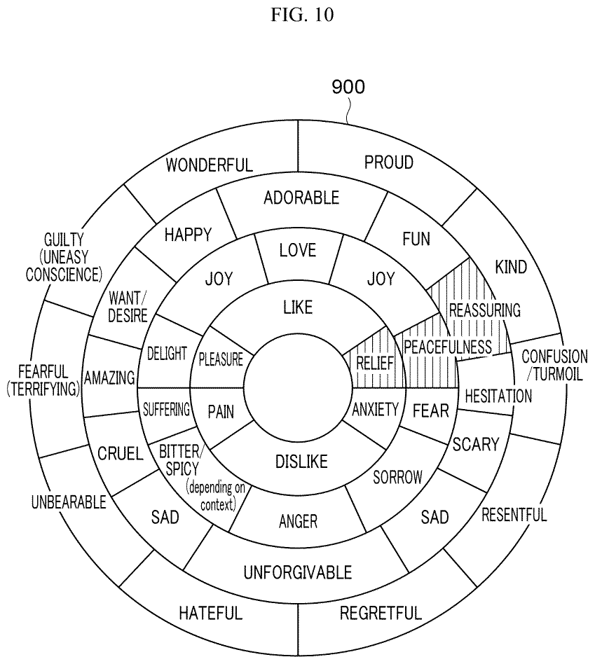

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
acquire audio information from a user and convert the audio information into character information by performing speech recognition processing, and
generate a prompt sentence to be input to a generative AI model, based on the character information and device information including model information of a terminal, screen information, and application information, and
provide input information including the prompt sentence and the character information to the generative AI model and cause the generative AI model to generate response information including user intent and operation procedure information corresponding to the user intent, and
analyze the response information to extract intent information and the operation procedure information, and convert the operation procedure information into a plurality of operation step information items associated with a screen configuration of the terminal and an operation target element, and
for each of the plurality of operation step information items, extract an operation target region on a screen and superimpose and present visual guidance information including at least one of highlight display, arrow display, and frame display on the operation target region, and for each of the plurality of operation step information items, generate an explanation sentence representing operation content, convert the explanation sentence into audio information by performing speech synthesis processing, and output the audio information, and
monitor operation events occurring in the terminal, and when determining that an operation event corresponds to a current step among the plurality of operation step information items, record the current step as completed and automatically transition to a next step, and
store the operation events and the plurality of operation step information items as history information, and predict a future intent of the user or a next operation of the user based on the history information, and individualize at least one of the prompt sentence to the generative AI model and the operation procedure information based on a result of the prediction.

### (Supplementary 2)

The system according to supplementary 1,
wherein the processor is configured to
adjust display parameters and audio parameters including at least one of font size, display color, layout, audio output speed, and length of the explanation sentence based on attribute information of the user, and generate a user interface corresponding to the plurality of operation step information items in a form optimized for elderly users.

### (Supplementary 3)

The system according to supplementary 1,
wherein the processor is configured to
automatically generate the prompt sentence for the generative AI model based on the history information and the device information, provide character information including a request from the user to the generative AI model using the prompt sentence, and cause the generative AI model to generate the response information including operation procedure information indicating an optimal operation method or an optimal transaction method according to at least one of a past operation history of the user and a past transaction history of the user.

### Application Example 1

### (Supplementary 1)

A system comprising a processor,
wherein the processor is configured to
acquire voice information from a user and convert the voice information into character information by using a speech recognition algorithm,
analyze the character information by using a natural language processing technique and a generative information processing model, and thereby identify an intention of the user and a target object,
obtain position information corresponding to the identified target object from storage information, and generate route information on the basis of current position information of the user and the position information,
generate a prompt sentence for the generative information processing model on the basis of the route information, the position information, and the intention of the user, and generate voice guidance information and display guidance information by using the generative information processing model in accordance with the prompt sentence, and
output voice guidance by using a speech synthesis technique on the basis of the voice guidance information, and visually present route guidance on a display device on the basis of the display guidance information and the route information.

### (Supplementary 2)

The system according to supplementary 1,
wherein the processor is configured to
perform interface generation that adjusts contents and presentation formats of the display guidance information and the voice guidance information for elderly users on the basis of user attribute information.

### (Supplementary 3)

The system according to supplementary 1,
wherein the processor is configured to
generate the prompt sentence for the generative information processing model on the basis of user-related information including usage history information and transaction history information, and input the prompt sentence to the generative information processing model so as to generate transaction procedure information and guidance information to be presented to the user.

### Example 2

### (Supplementary 1)

A system comprising a processor,
wherein the processor is configured to
acquire voice input and text input from a user, convert the voice input into text data by using a voice recognition algorithm, and accept the text input and the converted text data as a prompt sentence,
obtain operational information and historical inquiry information from an information storage apparatus within an organization, perform preprocessing including data cleaning, normalization, and tokenization on the obtained information, and train a generative artificial intelligence model by using a machine learning algorithm based on the preprocessed data so as to construct a trained generative artificial intelligence model,
convert the prompt sentence into input data for the trained generative artificial intelligence model, execute inference processing on the trained generative artificial intelligence model, and generate a response sentence corresponding to the prompt sentence,
present the response sentence to the user by using a voice synthesis technique and display of a display device,
record operation history related to the prompt sentence and the response sentence from the user, train an auxiliary model to predict a future operation or a future inquiry content of the user by using the operation history, and generate, based on the auxiliary model, a recommended prompt sentence or an operation candidate to be presented to the user, and present the generated recommended prompt sentence or the operation candidate on a user interface and, in response to a selection operation by the user, re-input the recommended prompt sentence as the prompt sentence to the generative artificial intelligence model.

### (Supplementary 2)

The system according to supplementary 1,
wherein the processor is configured to dynamically change a display format and an input method of the user interface based on user attribute information and operation history information, and to generate a customized interface with reduced cognitive load for a user including an elderly user.

### (Supplementary 3)

The system according to supplementary 1,
wherein the processor is configured to include behavioral history data and transaction history data of the user as learning data for the generative artificial intelligence model, and, at a time of inference, to generate, based on the behavioral history data and the transaction history data, a prompt sentence candidate and a response sentence that propose a transaction policy or an operational procedure suitable for the user.

### Application Example 2

### (Supplementary 1)

A system comprising a processor,
wherein the processor is configured to
acquire input information from a terminal device operated by a user, the input information including at least one of voice information, text information, operation information, transaction information and biometric information,
convert the voice information included in the input information into character information by using a speech recognition algorithm,
record the operation information included in the input information as an operation history together with time-series information, and store the operation history in a storage,
analyze the character information and the operation history by using a natural language processing technique and a statistical processing technique, and extract intention information of the user and state information of the user,
estimate emotion information of the user on the basis of at least one of the character information, the voice information and facial expression information included in the biometric information,
train an action prediction model and a payment prediction model by using a machine learning algorithm on the basis of the operation history and a transaction history,
generate a prompt sentence to be input to a generative AI model, the prompt sentence being generated on the basis of at least one of the intention information, the state information, the emotion information, the action prediction model, the payment prediction model and external information resources,
cause the generative AI model to operate by using the prompt sentence, and generate response information including at least one of procedure information, operation guidance information, payment recommendation information and inquiry response information,
generate support information for automatically or semi-automatically assisting at least one of application activation, function execution and payment processing in the terminal device on the basis of the response information, the action prediction model and the payment prediction model,
present the response information and the support information to the user by using a display device for visual presentation and a voice synthesis technique for auditory presentation, and acquire feedback information including operation information and emotion information of the user in response to the presentation, and update at least one of the action prediction model, the payment prediction model and processing for generating the prompt sentence on the basis of the feedback information.

### (Supplementary 2)

The system according to supplementary 1,
wherein the processor is configured to
generate a user interface used for the presentation, the user interface being dynamically changed, on the basis of the emotion information and attribute information of the user including whether the user is an elderly person, with respect to at least one of character display format, voice guidance speed, level of detail of explanation and structure of operation procedures.

### (Supplementary 3)

The system according to supplementary 1,
wherein the processor is configured to
generate a prompt sentence for proposing an optimal payment method, on the basis of a next payment timing and a payment method estimated by the payment prediction model, the emotion information and the transaction history, the optimal payment method including at least one of a payment means, an installment condition and a payment timing, and input the prompt sentence to the generative AI model to generate response information including payment recommendation information.

What is claimed is:

1. A system comprising:
circuitry configured to:
receive, via a communication interface coupled to a packet-switched network, audio information from a terminal device and device information comprising model information, screen information, and application information of the terminal device;
apply speech recognition processing to the audio information to produce character information, generate a prompt sentence based on the character information and the device information, and input the prompt sentence together with the character information to a generative neural network model to obtain response information comprising intent data and operation procedure information;
transmit the response information to the terminal device via the communication interface;
receive operation event data from the terminal device, determine whether an operation event corresponds to a current step among a plurality of operation step information items derived from the operation procedure information, record the current step as completed upon correspondence, and transmit a step transition signal to the terminal device; and
store the operation event data and the plurality of operation step information items as history information, predict at least one of a future intent or a next operation of a user based on the history information, and individualize at least one of the prompt sentence and the operation procedure information based on the prediction.

2. The system of claim 1, wherein the speech recognition processing applies a neural network-based automatic speech recognition model that maps acoustic feature vectors extracted per audio frame to text token sequences using beam search decoding.

3. The system of claim 2, wherein the circuitry is configured to generate the prompt sentence by concatenating the character information with structured device context fields derived from the model information, the screen information, and the application information, encoding the structured device context fields as key-value pairs in a context section of the prompt sentence.

4. The system of claim 3, wherein the circuitry is configured to extract the intent data and the operation procedure information from the response information by parsing output tokens using a pattern matching algorithm that identifies intent label tokens and numbered step tokens.

5. The system of claim 4, wherein the circuitry is configured to map each operation step information item to an operation target element by resolving element references in the step tokens against a UI element index derived from the screen information.

6. The system of claim 1, wherein the terminal device is configured to superimpose visual guidance information comprising at least one of a highlight display, an arrow display, and a frame display on an operation target region corresponding to each operation step information item.

7. The system of claim 6, wherein the terminal device generates an explanation sentence representing operation content for each operation step information item and converts the explanation sentence into audio output information by applying speech synthesis processing.

8. The system of claim 7, wherein the terminal device monitors operation events by subscribing to a system-level event stream and compares detected event types and target element identifiers against the current step information item to determine correspondence.

9. The system of claim 1, wherein the history information comprises per-step records storing operation event type, timestamp, target element identifier, completion status, and an associated step information item identifier.

10. The system of claim 9, wherein predicting the future intent or the next operation applies a sequence prediction model to temporally ordered operation event records in the history information, outputting a ranked list of candidate intent labels with associated probability scores.

11. The system of claim 10, wherein individualizing the prompt sentence comprises inserting a personalization section into the prompt sentence encoding the ranked candidate intent labels with probability scores, conditioning the generative neural network model to emphasize high-probability intent paths in the operation procedure information.

12. The system of claim 11, wherein the circuitry is configured to update the sequence prediction model periodically using newly accumulated history information by performing mini-batch parameter updates with a gradient-based optimization algorithm.

13. The system of claim 1, wherein the circuitry is configured to adapt output display characteristics of the visual guidance information based on user profile attributes stored in a storage device, increasing visual guidance element sizes and decreasing information density for user profiles indicating simplified display requirements.

14. The system of claim 13, wherein the user profile attributes are updated based on interaction patterns extracted from the history information, and the circuitry is configured to apply a classification model to the interaction patterns to infer display preference categories.

15. The system of claim 1, wherein the response information further comprises a difficulty level indicator for each operation step information item, and the circuitry is configured to transmit an extended explanation request to the generative neural network model when the difficulty level indicator exceeds a threshold value.

16. The system of claim 15, wherein the extended explanation request comprises a follow-up prompt sentence incorporating the operation step information item and a verbosity instruction parameter, and the resulting extended explanation is appended to the response information for transmission to the terminal device.

17. The system of claim 1, wherein the circuitry is configured to generate a session summary record upon completion of all operation step information items, storing the intent data, step completion sequence, total interaction duration, and error step indicators as a structured session record in a storage device.

18. A system comprising:
circuitry configured to:
receive, via a communication interface coupled to a packet-switched network, audio information and device information comprising model information, screen information, and application information from a terminal device;
apply speech recognition processing using a neural network-based automatic speech recognition model to produce character information, construct a prompt sentence concatenating the character information with structured device context fields, and input the prompt sentence to a generative neural network model to obtain intent data and operation procedure information;
transmit the operation procedure information to the terminal device as a plurality of operation step information items mapped to operation target elements resolved from the screen information, wherein the terminal device superimposes visual guidance information on operation target regions and generates step-specific audio output information via speech synthesis;
receive operation event data, determine correspondence between each operation event and a current step, record completed steps, and transmit step transition signals to the terminal device; and
store operation event data and step information items as history information, apply a sequence prediction model to the history information to predict future intent, and individualize the prompt sentence by inserting personalization sections encoding candidate intent labels with probability scores.

19. The system of claim 18, wherein the circuitry is configured to update the sequence prediction model using newly accumulated history information by performing mini-batch parameter updates, and to adapt visual guidance information display characteristics based on user profile attributes derived by applying a classification model to interaction patterns in the history information.

20. A method comprising:
receiving, via a communication interface coupled to a packet-switched network, audio information and device information from a terminal device and applying speech recognition processing to the audio information to produce character information;
generating a prompt sentence based on the character information and the device information and inputting the prompt sentence to a generative neural network model to obtain response information comprising intent data and operation procedure information;
transmitting the response information to the terminal device;
receiving operation event data from the terminal device, determining whether each operation event corresponds to a current step among operation step information items, recording completed steps, and transmitting step transition signals; and
storing the operation event data and the operation step information items as history information, predicting at least one of a future intent or a next operation of a user based on the history information, and individualizing at least one of the prompt sentence and the operation procedure information based on the prediction.
